(19) United States
(12) Patent Application Publication
(10) Pub. No.: US 2026/0042000 A1
(43) Pub. Date: Feb. 12, 2026

(54) HUMAN-COMPUTER INTERACTION

(71) Applicant: Tencent Technology (Shenzhen) Company Limited, Shenzhen (CN)

(72) Inventors: Yixuan WANG, Shenzhen (CN); Po-An SHEN, Shenzhen (CN); Muyu XU, Shenzhen (CN); Beijin LI, Shenzhen (CN); Tong ZHOU, Shenzhen (CN); Yinxiang SUN, Shenzhen (CN); Rui WANG, Shenzhen (CN); Junling GUO, Shenzhen (CN)

(73) Assignee: Tencent Technology (Shenzhen) Company Limited, Shenzhen (CN)

(21) Appl. No.: 19/362,139

(22) Filed: Oct. 17, 2025

Related U.S. Application Data
(63) Continuation of application No. 18/786,199, filed on Jul. 26, 2024.
Application No. 18/786,199 is a continuation of application No. PCT/CN2023/099503, filed on Jun. 9, 2023.

(30) Foreign Application Priority Data
Aug. 19, 2022 (CN) 202211003350.4

(51) Int. Cl. A63F 13/219; A63F 13/2145; A63F 13/426; A63F 13/577

(52) U.S. Cl. CPC A63F 13/219; A63F 13/2145; A63F 13/426; A63F 13/577

(57) ABSTRACT

In a human-computer interaction method, a main virtual character in a virtual environment is displayed. A list interface including a first control corresponding to a container prop that is possessed by the main virtual character and contains a first pet virtual character is displayed. Release of the first pet virtual character in the virtual environment is displayed based on a throwing operation indicative of a throw of the container prop, the throwing operation being based on at least the first control included in the list interface. An interaction between the first pet virtual character and the virtual environment at a location of the first pet virtual character in the virtual environment is displayed based on a first attribute of the first pet virtual character.

### RELATED APPLICATIONS

The application is a continuation of U.S. application Ser. No. 18/786,199, filed on Jul. 26, 2024, which is a continuation of International Application No. PCT/CN2023/099503, filed on Jun. 9, 2023, which claims priority to China Patent Application No. 202211003350.4, entitled “HUMAN-COMPUTER INTERACTION METHOD AND APPARATUS BASED ON VIRTUAL WORLD, DEVICE, MEDIUM, AND PRODUCT” and filed on Aug. 19, 2022. The disclosures of the prior applications are hereby incorporated by reference in their entirety.

### FIELD OF THE TECHNOLOGY

Aspects of the present disclosure relate to the field of human-computer interaction, including a human-computer interaction method and apparatus based on virtual world, a device, a medium, and a product.

### BACKGROUND OF THE DISCLOSURE

In non-combat scenes of some turn-based games, master virtual characters move in a world map, and in combat scenes, master virtual characters control captured pet virtual characters in a combat map to perform turn-based combats with enemy units (monsters or pet virtual characters captured by other characters).

In a typical turn-based game, taking a non-combat scene as an example, a master virtual character moves in a world map, and the master virtual character throws a pet virtual character in the world map to make the pet virtual character move in the world map.

However, when throwing a pet virtual character, the pet virtual character needs to be selected through the joystick in a backpack selection interface. After selecting the pet virtual character, the world map interface is returned to and the pet virtual character is thrown through a joystick. Therefore, the entire throwing process is very complex.

### SUMMARY

This disclosure provides a human-computer interaction method and apparatus based on virtual world, a device, a medium, and a product. The technical solutions are as follows.

In an aspect, a method includes displaying a list interface including a first container prop that contains a first pet virtual character and a second container prop that does not contain a pet virtual character. The method further includes, in response to a touch selection operation corresponding to selecting one of the first container prop or the second container prop, displaying an aiming interface corresponding to the selected one of the first container prop or the second container prop and displaying an aiming sight. The method further includes, in response to a touch aiming operation on the aiming interface, adjusting a position of the displayed aiming sight. The method further includes, when the first container prop is selected, displaying throwing the first pet virtual character in response to a touch throwing operation, and when the second container prop is selected, displaying throwing the second container prop in response to the touch throwing operation.

In an aspect, an apparatus includes processing circuitry configured to display a list interface including a first container prop that contains a first pet virtual character and a second container prop that does not contain a pet virtual character. The processing circuitry is further configured to, in response to a touch selection operation corresponding to selecting one of the first container prop or the second container prop, display an aiming interface corresponding to the selected one of the first container prop or the second container prop and display an aiming sight. The processing circuitry is further configured to, in response to a touch aiming operation on the aiming interface, adjust a position of the displayed aiming sight. The processing circuitry is further configured to, when the first container prop is selected, display throwing the first pet virtual character in response to a touch throwing operation, and when the second container prop is selected, display throwing the second container prop in response to the touch throwing operation.

In an aspect, a non-transitory computer-readable storage medium stores computer-readable instructions, which, when executed by processing circuitry, cause the processing circuitry to perform a method that includes displaying a list interface including a first container prop that contains a first pet virtual character and a second container prop that does not contain a pet virtual character. The method further includes, in response to a touch selection operation corresponding to selecting one of the first container prop or the second container prop, displaying an aiming interface corresponding to the selected one of the first container prop or the second container prop and displaying an aiming sight. The method further includes, in response to a touch aiming operation on the aiming interface, adjusting a position of the displayed aiming sight. The method further includes, when the first container prop is selected, displaying throwing the first pet virtual character in response to a touch throwing operation, and when the second container prop is selected, displaying throwing the second container prop in response to the touch throwing operation.

The technical solutions provided in this disclosure have at least the following beneficial effects:

A list control (or list interface) is displayed, a control corresponding to at least one container prop being displayed on the list control, and the at least one container prop including a first container prop that contains a first pet virtual character, and/or a second container prop that does not contain a pet virtual character. By triggering a touch selection operation on the control corresponding to the container prop, an aiming joystick (or aiming interface) corresponding to the selected container prop is displayed and an aiming front sight (or aiming sight) is displayed. Therefore, an aiming location of the aiming front sight may be changed through the touch aiming operation on the aiming joystick. After adjusting the aiming location, the touch throwing operation on the container prop is triggered to throw the container prop. If the thrown container prop is the first container prop, the thrown first pet virtual character is displayed. If the thrown container prop is a second container prop, the thrown second container prop is displayed. Selection and throwing operations of the pet virtual character are performed, and the interactive behavior between the pet virtual character and the virtual world is implemented based on the thrown pet virtual character, improving the efficiency of human-computer interaction.

### BRIEF DESCRIPTION OF THE DRAWINGS

FIG. 1 is a schematic diagram of a combat map according to an exemplary aspect of this disclosure;

FIG. 2 is a schematic diagram of a combat map according to an exemplary aspect of this disclosure;

FIG. 3 is a schematic diagram of a human-computer interaction method based on virtual world according to an exemplary aspect of this disclosure;

FIG. 4 is a structural block diagram of a computer system according to an exemplary aspect of this disclosure;

FIG. 5 is a flowchart of a human-computer interaction method based on virtual world according to an exemplary aspect of this disclosure;

FIG. 6 is a flowchart of a human-computer interaction method based on virtual world according to an exemplary aspect of this disclosure;

FIG. 7 is a schematic diagram of a first container prop in a list control according to an exemplary aspect of this disclosure;

FIG. 8 is a schematic diagram of a second container prop in a list control according to an exemplary aspect of this disclosure;

FIG. 9 is a schematic diagram of throwing by a master virtual character according to an exemplary aspect of this disclosure;

FIG. 10 is a schematic diagram of a display style of an aiming front sight having an interactive style according to an exemplary aspect of this disclosure;

FIG. 11 is a schematic diagram of releasing a first pet virtual character by a master virtual character according to an exemplary aspect of this disclosure;

FIG. 12 is a schematic diagram of collecting a virtual collection object by a first pet virtual character according to an exemplary aspect of this disclosure;

FIG. 13 is a schematic diagram of capturing a second pet virtual character according to an exemplary aspect of this disclosure;

FIG. 14 is a schematic diagram of a capture success rate identifier according to an exemplary aspect of this disclosure;

FIG. 15 is a schematic diagram of throwing a first pet virtual character for combating according to an exemplary aspect of this disclosure;

FIG. 16 is a schematic diagram of interaction between a first pet virtual character and a virtual environment according to an exemplary aspect of this disclosure;

FIG. 17 is a schematic diagram of interaction between a first pet virtual character and a virtual environment according to an exemplary aspect of this disclosure;

FIG. 18 is a schematic diagram of interaction between a first pet virtual character and a virtual environment according to an exemplary aspect of this disclosure;

FIG. 19 is a schematic diagram of interaction between a first pet virtual character and a virtual environment according to an exemplary aspect of this disclosure;

FIG. 20 is a schematic diagram of interaction between a container prop and a virtual environment according to an aspect of this disclosure;

FIG. 21 is a schematic diagram of interaction between a container prop and a virtual environment according to an aspect of this disclosure;

FIG. 22 is a flowchart of human-computer interaction based on virtual world according to an exemplary aspect of this disclosure;

FIG. 23 is a block diagram of a human-computer interaction apparatus based on virtual world according to an exemplary aspect of this disclosure; and

FIG. 24 is a schematic structural diagram of a computer device according to an exemplary aspect of this disclosure.

### DETAILED DESCRIPTION

First, several terms involved in the aspects of this disclosure are briefly introduced.

Virtual world: virtual world displayed (or provided) when an application program runs on a terminal. The virtual world can be a simulation environment of the real world, a semi-simulation and semi-fictional environment, or a purely fictional environment. The virtual world can be any one of a two-dimensional virtual world, a 2.5-dimensional virtual world, and a three-dimensional virtual world, which is not limited in this disclosure. In the following aspects, for example, the virtual world is a three-dimensional virtual world.

Main control virtual character: movable objects played by players in the virtual world. The master virtual character can be a virtual person, a virtual animal, or an animation character, such as: persons and animals displayed in the three-dimensional virtual world. In some aspects, the master virtual character is a three-dimensional model created based on an animation skeleton technology. Each master virtual character has a shape and a volume in the three-dimensional virtual world and occupies a part of the space in the three-dimensional virtual world.

Pet virtual character: movable objects controlled by artificial intelligence (AI) in the virtual world. Pet virtual characters can be virtual creatures, virtual animals, virtual monsters, virtual spirits, or virtual pets, such as: movable objects in the form of animals or other forms displayed in a three-dimensional virtual world. The master virtual character can perform at least one of interactive behaviors of capturing, raising, upgrading, and the like on the pet virtual character. The pet virtual character can assist the master virtual character in at least one of interactive behaviors of collecting, combating, changing land parcels, and the like.

In a turn-based role-playing game (RPG), players play a virtual character in a real world or a virtual world. The turn-based RPG offers two types of maps: world map and combat map. In non-combat scenes, virtual characters move in the world map, such as playing, capturing pet virtual characters, collecting treasure boxes, and collecting virtual props. In combat scenes, virtual characters control captured pet virtual characters in the combat map, and perform turn-based combat with enemy units (such as non-player characters (NPC), AI-controlled monsters, or pet virtual characters captured by other characters in the game).

Since the world map and the combat map are two completely different maps, when switching between the world scene (or non-combat scene) and the combat scene, the user interface displays very different map content. Players can clearly feel the difference between the two different maps, and there is a strong feeling of tearing. In order to alleviate this tearing feeling, a transition animation is often displayed when switching, but the effect is still not good.

In the aspects of this disclosure, an innovative turn-based RPG mechanism is provided. The turn-based RPG combines the traditional world map and combat map into one map. The combat map is a sub-map dynamically determined from the world map during each combat. In this way, when switching between the world scene (or non-combat scene) and the combat scene, there is no huge difference in the map content displayed in the user interface, thereby avoiding the tearing feeling. Moreover, the turn-based RPG also allows the environment in the virtual world (weather, time, land parcel, or the like) to affect the master virtual character, the pet virtual character and the combat process, and conversely, the master virtual character, the pet virtual character and the combat process also affect the environment in the virtual world, thereby organically integrating the turn-based combat process into the virtual world. The combat is no longer two torn parts, and instead forms a whole.

A game flow of the turn-based RPG includes: a capture process and a combat process.

Capture process:

1. In a virtual scene, a pet virtual character is found. When a master virtual character approaches the pet virtual character within a range, a virtual scene screen displays a face-to-face capture scene of the pet virtual character. In this case, the pet virtual character may remain still, move around, or threaten or attack the master virtual character.

2. A spherical container prop is prepared, for example, a spherical container prop is selected.

3. The spherical container prop is used to aim at the pet virtual character. The body of the pet virtual character displays capture-related information, such as capture difficulty (indicated by color, for example, difficulty represented by green<difficulty represented by orange<difficulty represented by red). The virtual scene screen displays the attribute of the pet virtual character (including a name, a gender, a level, and a comprehensive attribute value). The virtual scene screen also displays an aiming circle. The aiming circle repeats the process of shrinking and enlarging over time. When the aiming circle shrinks, the spherical container prop is thrown towards the pet virtual character, and chance of successfully catching is higher.

4. The spherical container prop is thrown to the pet virtual character to capture the pet virtual character. The throwing effect can be achieved through the touch control on the touch screen.

If a throwing location and/or a throwing timing is incorrect, the capture fails and a capture failure prompt is displayed. If the throwing location and the throwing timing are both correct, but the level or strength of the master virtual character is insufficient, the capture fails and a capture failure prompt is displayed. If the throwing location and the throwing timing are both correct, and the level or strength of the master virtual character is sufficient, the capture succeeds, and a capture success prompt, rewards for successful capture (such as experience points and newly acquired skills), and an attribute of the captured pet virtual character (such as a name, a gender, a height, a weight, a number, a skill, rarity, and a personality trait) are displayed.

Fight process: The combat can be a single combat, a double combat, or a team combat.

1. A pet virtual character is selected for combat.

2. A combat scene is displayed and a skill used by the pet virtual character is selected.

3. A touch control on the touch screen is controlled to release a skill.

4. A skill animation effect is displayed.

In the aspects of this disclosure, the turn-based RPG has innovative designs in at least the following parts:

### World Map

The world map includes multiple land parcels. Each land parcel is polygonal. The polygonal land parcel can be any one of square, rectangle, and hexagon. For example, each land parcel is a 50 cm×50 cm square. Each land parcel has a surface attribute. The surface attribute includes grass, stone, water, or the like. In addition, the multiple land parcels included in the world map can be of the same type, or a combination of multiple different types.

### Fight Map

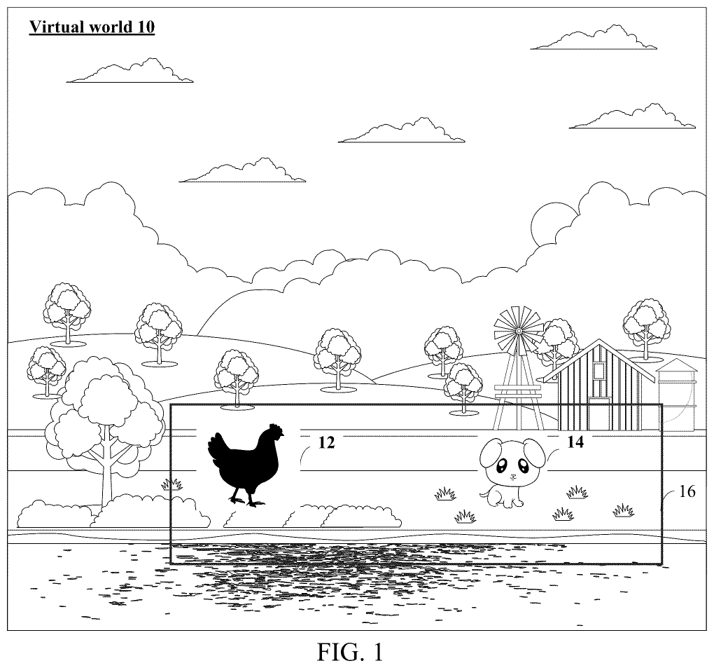

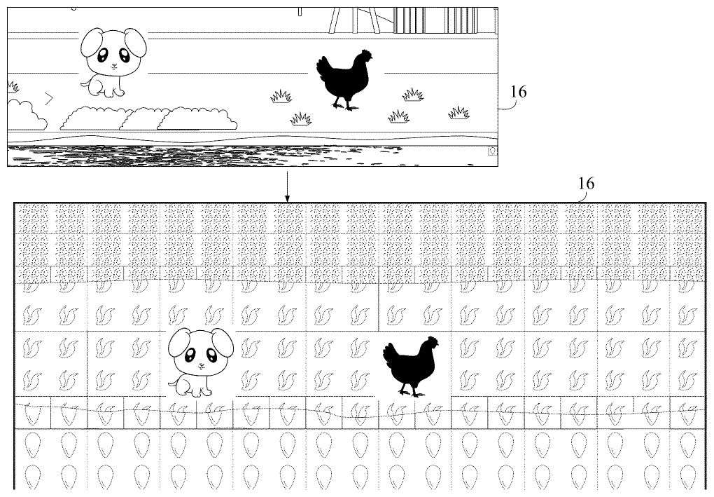

Referring to FIG. 1 and FIG. 2, in a virtual world 10, when a first pet virtual character 12 encounters a second pet virtual character 14 at a location in the world map and enters a combat, one or more land parcels within a range using a reference location determined by the first pet virtual character 12 as the center in the world map are determined as a combat map 16. The reference location is a location where the first pet virtual character 12 is located, or a suitable combat location closest to the first pet virtual character 12. In some aspects, the combat map 16 includes all land parcels within a circular range with the reference location as the center and a predetermined length as the radius. In some aspects, the combat map 16 includes all land parcels within a rectangular range with the reference location as the center and with a predetermined length and width.

### World Scene and Combat Scene

The world scene refers to a scene corresponding to the world map. When a user interface displays the world scene, the user interface can display one or more land parcels in the world map. For example, the user interface displays one or more land parcels where the master virtual character or the pet virtual character is currently located in the world map, as well as some interface elements related to the displayed land parcels, the master virtual character, the pet virtual character, and the like.

The combat scene refers to a scene corresponding to the combat map. When the user interface displays the combat scene, the user interface can display the combat map, for example, display all or some of land parcels included in the combat map. For example, the user interface displays one or more land parcels where the master virtual character or the pet virtual character is currently located in the combat map, as well as some interface elements related to the displayed land parcels, the master virtual character, the pet virtual character, and the like.

Switching between the world scene and the combat scene can be implemented, for example, from the world scene to the combat scene, or from the combat scene to the world scene.

A virtual camera can adopt different shooting perspectives when displaying world scenes and combat scenes. For example, when displaying a world scene, the virtual camera shoots the world scene from the perspective of the master virtual character (for example, the first-person perspective or the third-person perspective of the master virtual character) to obtain a display screen of the world scene. When displaying the combat scene, the virtual camera shoots the combat scene from a middle perspective (for example, the virtual camera is located in the middle and diagonally above the two combatants) to obtain a display screen of the combat scene. In some aspects, in the world scene and the combat scene, in addition to the shooting perspective being different, allowed user operations can also be different. For example, when displaying a world scene, a user is allowed to manually adjust the perspective, and the user is allowed to control the movement of the main virtual character or the pet virtual character. When displaying a combat scene, the user is not allowed to manually adjust the perspective, and the user is not allowed to control the movement of the master virtual character or the pet virtual character. Through the above method, the user can make a perceptual distinction between the world scene and the combat scene. The world scene and the combat scene share the same world map, and the combat map used in the combat scene is one or more land parcels in the world map. Therefore, the switching between the world scene and the combat scene does not bring a strong sense of tearing, and instead very smooth and natural switching.

### Potential Energy

Potential energy is an element, an attribute, or an identifier in the virtual world that affects combat. Potential energy includes at least one of grass type, fire type, water type, stone type, ice type, electric type, poison type, light type, ghost type, demon type, normal type, martial type, cute type, fantasy type, insect type, wing type, dragon type, and mechanical type.

### Capture of Pet Virtual Character

The master virtual character owns at least one spherical container prop, and the spherical container prop is configured to capture, store, raise or release the pet virtual character. The master virtual character captures the pet virtual character by throwing an empty spherical container prop, or releases the pet virtual character by throwing a spherical container prop storing the pet virtual character. For example, spherical container props are called monster balls or poke balls or gulu balls.

For capturing a pet virtual character, when a capture threshold is greater than an energy value of the pet virtual character, the pet virtual character is in a “capture-able state”. The user interface displays a prompt message that the pet virtual character is in a “capture-able state”, to assist players in capturing. The capture threshold is affected by factors such as the player operation, the weather, the environment, and the number of capture times. For example, players can feed fruits, use special skills, attack or perform other operations, and the capture threshold can be changed through the weather, the time, and other conditions in the game. At the same time, the prompt information is used to assist players to capture in a friendly manner, for example, by feeding food and changing the environment, instead of capturing through combat, to reflect the design purpose that the pet virtual character is a good friend of the master virtual character.

The released pet virtual character can stay in the virtual scene and interact with the master virtual character, can perform collection behaviors, and can combat with other pet virtual characters. In addition, the released pet virtual character interacts with the environment in the virtual world, for example, activates a potential energy mechanism to change potential energy of the surrounding environment, obtains a virtual item with an attribute lock in a treasure box, and affects an attribute of a land parcel in the virtual environment, such as, burns grass and freezes a lake.

The spherical container prop also simulates a physical property of a real spherical object, and can bounce back when encountering an obstacle and can also float on the water.

### A Combat Process Changes the World Environment

During a turn-based combat between pet virtual characters, a skill released by a pet virtual character affects the environment of the virtual world, and this is synchronized from the combat scene to the world scene. For example, if a pet virtual character combats in a combat scene, and the pet virtual character releases a fire skill, the grass patch in the combat scene is ignited, and the ignited grass patch is synchronized to the world scene. Further, after the environment of the land parcel changes, the pet virtual character is affected.

### The World Environment Changes a Combat Process

During a turn-based combat between pet virtual characters, the environment in the virtual world affects the pet virtual character, for example, affects skill damage of the pet virtual character or affects a skill display effect of the pet virtual character. For example, the environment in the virtual world includes the environment of the land parcel and the environment of the weather. These two aspects comprehensively affect the extent to which the pet virtual character hates or likes the environment. For example, the extent to which the pet virtual character hates or likes the environment includes the following different levels: strong affinity, weak affinity, insensitivity, weak resistance, and strong resistance.

If the pet virtual character likes both the environments (land parcel+weather), a strong affinity effect is obtained. If the pet virtual character likes one environment and does not dislike the other environment, a weak affinity effect is obtained. If the pet virtual character likes one environment and hates the other environment, no effect is obtained. If the pet virtual character hates one environment and dislikes the other environment, a weak resistance effect is obtained. If the pet virtual character hates both the environments, a strong resistance effect is obtained.

During the combat, a server or a client needs to obtain the environment regularly (such as every turn) and determine the impact of the environment on the pet virtual character.

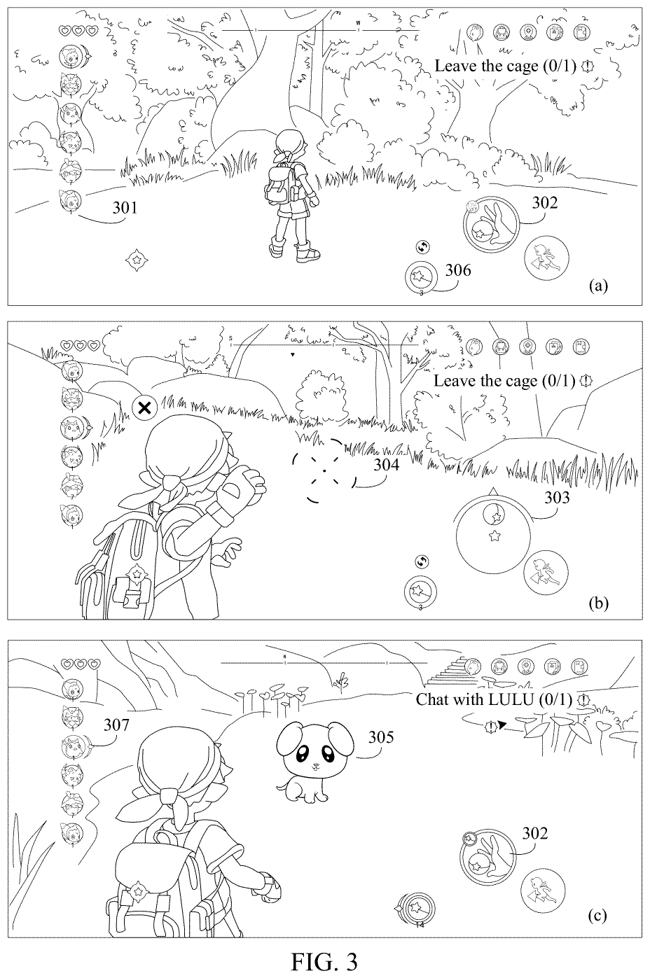

The aspects of the present disclosure provide a technical solution for a human-computer interaction method based on virtual world. The method can be executed by a terminal or a client on the terminal. As shown in (a) of FIG. 3, a list control is displayed in the terminal, and a control corresponding to at least one first container prop 301 that contains a first pet virtual character, and/or a control corresponding to at least one second container prop 306 that does not contain a pet virtual character are displayed in the list control.

For example, the control corresponding to the first container prop 301 that contains the first pet virtual character is displayed in a pet virtual character selection area, and the control corresponding to the first container prop 301 is represented by an avatar identifier of the pet virtual character. Level information of the pet virtual character is displayed below the avatar identifier of the pet virtual character. The control corresponding to at least one second container prop 306 that does not contain a pet virtual character is displayed in a prop selection area, and a throwing button 302 is displayed on the user interface.

In some aspects, the container prop can implement at least one of the following functions:
capture a pet virtual character;
load a pet virtual character;
transfer a pet virtual character; and
treat a pet virtual character.

In some aspects, the shape of the container prop is at least one of spherical, square, rectangular, triangular cone, and cylindrical, but is not limited to this, and the aspects of the present disclosure do not specifically limit this. In this aspect, for example, the container prop is a spherical container prop.

In some aspects, the container prop can be obtained through at least one of picking up, snatching, and purchasing, but the obtaining method is not limited to this, and this disclosure does not limit this.

Pet virtual characters refer to movable objects in the virtual world.

In some aspects, the master virtual character can perform at least one of interactive behaviors of capturing, raising, upgrading, and the like on the pet virtual character, but is not limited to this, and this disclosure does not limit this.

In some aspects, the pet virtual character can assist the master virtual character in at least one of interactive behaviors of collecting, combating, changing land parcels, and the like, but is not limited to this, and this disclosure does not limit this.

For example, as shown in (b) of FIG. 3, in response to a touch selection operation on a control corresponding to a container prop in the list control, the terminal displays an aiming joystick 303 corresponding to the selected container prop and displays an aiming front sight 304.

The aiming joystick 303 is configured to control the aiming location indicated by the aiming front sight 304.

The aiming front sight 304 is configured to assist the master virtual character in aiming at the aiming location.

For example, taking the throwing of a virtual prop as an example, the master virtual character aims the aiming front sight 304 at a location A. Then, after being thrown, the virtual prop falls at the location A, or the virtual prop falls near the location A.

In some aspects, in response to the touch selection operation on the list control, the terminal quickly throws the container prop by clicking on the throwing button 302. By long-pressing the throwing button 302, the throwing button 302 is switched to the aiming joystick 303, and the aiming location of the aiming front sight 304 is changed by controlling the aiming joystick 303, thereby changing the throwing direction.

For example, as shown in (c) of FIG. 3, in response to the throwing operation and that the selected container prop is the first container prop 301 that contains the first pet virtual character 305, the terminal displays the thrown first pet virtual character 305. After the first pet virtual character 305 is thrown, a selection identifier 307 is displayed on the right side of the first container prop 301 in the pet virtual character selection area. The selection identifier 307 is used to indicate that the pet virtual character has been selected. By clicking on the throwing button 302 again, the thrown first pet virtual character 305 can be retrieved into the first container prop 301.

The first pet virtual character refers to a virtual character belonging to the master virtual character. The first pet virtual character 305 is configured to interact with the virtual world.

Illustratively, the throwing method corresponding to the throwing operation includes at least one of high throwing, low throwing, and wall collision rebounding of the container prop. This disclosure is not limited to this, that is, the master virtual character can throw the container prop through at least one of high throwing, low throwing, and wall collision rebounding, but is not limited to this, and the aspects of this disclosure do not specifically limit this.

In some aspects, in response to the throwing operation and that the selected container prop is the first container prop 301 that contains the first pet virtual character, after the first container prop 301 that contains the first pet virtual character is thrown and hits the ground, the terminal displays the first pet virtual character in the first container prop 301 at the landing point.

For example, in response to the throwing operation and that the selected container prop is the second container prop 306 that does not contain the pet virtual character, the terminal displays the thrown second container prop 306.

To sum up, in the method provided by this aspect, a list control is displayed, in response to a touch selection operation on the list control, an aiming joystick corresponding to a selected container prop is displayed and an aiming front sight is displayed; in response to a touch aiming operation on the aiming joystick, the aiming front sight whose aiming location is changed is displayed; in response to a touch throwing operation and that the selected container prop is the first container prop, the thrown first pet virtual character is displayed; and in response to the touch throwing operation and that the selected container prop is the second container prop, the thrown second container prop is displayed. This disclosure provides a new human-computer interaction method based on virtual world. Selection and throwing operations of pet virtual characters are performed through the touch control on the touch screen. The interactive behavior between the pet virtual character and the virtual world is implemented based on the thrown pet virtual character. This assists the user to understand the pet virtual character faster through the interactive behavior between the pet virtual character and the virtual world, improves the efficiency of human-computer interaction, and enhances the user experience.

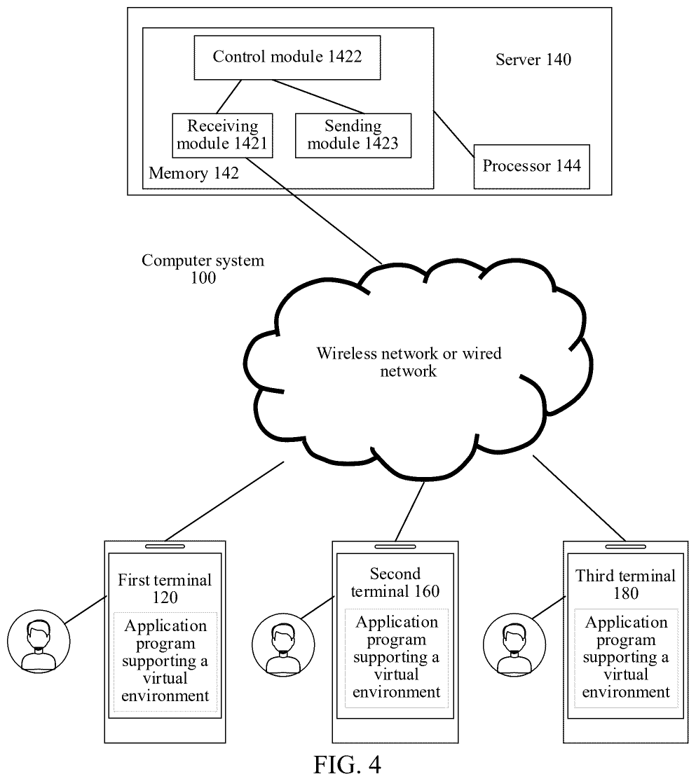

FIG. 4 is a structural block diagram of a computer system according to an exemplary aspect of this disclosure. The computer system 100 includes: a first terminal 120, a server 140, a second terminal 160, and a third terminal 180.

The first terminal 120 installs and runs an application program supporting the virtual world. The application program can be any one of a three-dimensional map program, a virtual reality (VR) application program, an augmented reality (AR) program, an RPG program, a turn-based game program, and a turn-based RPG program. The first terminal 120 is a terminal used by a first user. The first user uses the first terminal 120 to control a first virtual character located in the virtual world to perform activities. The first virtual character serves as a master virtual character. The activities include but are not limited to: at least one of adjusting a body posture, walking, running, jumping, riding, driving, aiming, picking up, capturing a pet virtual character, controlling a pet virtual character, raising a pet virtual character, using a pet virtual character to pick, using a pet virtual character to combat, using a throwing prop, and attacking other virtual characters. For example, the first virtual character is a first virtual person, such as a simulated person object or an animation person object. For example, the first user controls the first virtual character through the UI control on the virtual world screen to perform activities, and the first user controls the first virtual character to throw the pet virtual character through the UI control on the virtual world screen.

The first terminal 120 is connected to the server 140 by using a wireless network or a wired network.

The server 140 includes at least one of one server, multiple servers, a cloud computing platform, and a virtualization center. For example, the server 140 includes a processor (i.e., processing circuitry) 144 and a memory 142 (e.g., a non-transitory compute-readable storage medium). The memory 142 further includes a receiving module 1421, a control module 1422 and a sending module 1423. The receiving module 1421 is configured to receive a request sent by the client, for example, a request of detecting the location of the enemy virtual character. The control module 1422 is configured to control the rendering of a virtual world image. The sending module 1423 is configured to send a response to the client, for example, send a location of a third virtual character to the client. The server 140 is configured to provide background services for application programs that support the three-dimensional virtual world. In some aspects, the server 140 performs the main calculation work, and the first terminal 120, the second terminal 160 and the third terminal 180 perform the secondary calculation work. Alternatively, the server 140 performs the secondary calculation work, and the first terminal 120, the second terminal 160 and the third terminal 180 perform the main calculation work. Alternatively, the server 140, the first terminal 120, the second terminal 160 and the third terminal 180 use a distributed computing architecture to perform collaborative computing.

The second terminal 160 installs and runs an application program supporting the virtual world. The second terminal 160 is a terminal used by a second user. The second user uses the second terminal 160 to control a second virtual character located in the virtual world to perform activities. The second virtual character also serves as a master virtual character. The third terminal 180 installs and runs an application program supporting the virtual world. The third terminal 180 is a terminal used by a third user. The third user uses the third terminal 180 to control a third virtual character located in the virtual world to perform activities.

In some aspects, the first virtual character, the second virtual character and the third virtual character are in the same virtual world. The first virtual character and the second virtual character belong to different camps, and the second virtual character and the third virtual character belong to the same camp.

In some aspects, the application programs installed on the first terminal 120, the second terminal 160 and the third terminal 180 are the same, or the application programs installed on the three terminals are the same type of application program on different operating system platforms (Android or IOS). The first terminal 120 may generally refer to one of multiple terminals, the second terminal 160 may generally refer to one of multiple terminals, and the third terminal 180 may generally refer to one of multiple terminals. This aspect uses the first terminal 120, the second terminal 160 and the third terminal 180 for illustration. The device types of the first terminal 120, the second terminal 160 and the third terminal 180 are the same or different, and the device types include: at least one of a smartphone, a smart watch, a smart TV, a tablet, an e-book reader, an MP3 player, an MP4 player, a laptop computer, and a desktop computer. The following aspects take the terminal including a smartphone as an example.

A person skilled in the art knows that the number of the above terminals may be more or less. For example, there may be one terminal, or there may be dozens, hundreds, or more terminals. The aspects of the present disclosure do not limit the number of terminals and device types.

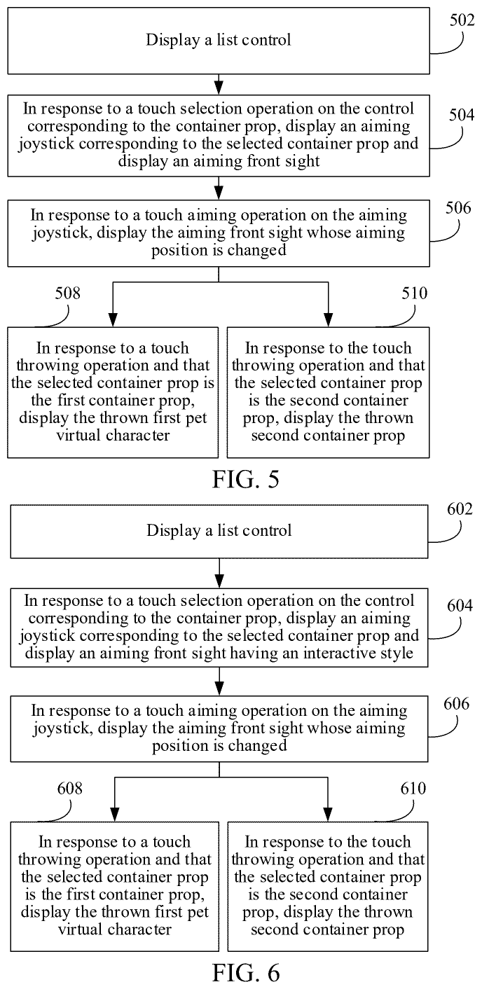

FIG. 5 is a flowchart of human-computer interaction based on virtual world according to an exemplary aspect of this disclosure. The method may be executed by a terminal in the system as shown in FIG. 4 or by a client on the terminal. This method includes:

Operation 502: Display a list control. For example, a list interface including a first container prop that contains a first pet virtual character and a second container prop that does not contain a pet virtual character is displayed.

A control corresponding to at least one first container prop that contains a first pet virtual character, and/or a control corresponding to at least one second container prop that does not contain a pet virtual character are displayed in the list control. That is, the list control includes a control corresponding to at least one container prop, and the at least one container prop including a first container prop that contains a first pet virtual character, and/or a second container prop that does not contain a pet virtual character. For example, the first container prop and the second container prop are located in the same list control. Alternatively, the first container prop and the second container prop are located in different list controls. The first container prop includes one or more props. The second container prop includes one or more props.

In some aspects, the container prop can implement at least one of the following functions:
capture a pet virtual character;
load a pet virtual character;
transfer a pet virtual character; and
treat a pet virtual character.

In some aspects, the shape of the container prop is at least one of spherical, square, rectangular, triangular cone, and cylindrical, but is not limited to this, and the aspects of the present disclosure do not specifically limit this. In this aspect, for example, the container prop is a spherical container prop.

In some aspects, the container prop can be obtained through at least one of picking up, snatching, and purchasing, but the obtaining method is not limited to this, and this disclosure does not limit this.

Pet virtual characters refer to movable objects in the virtual world.

In some aspects, the master virtual character can perform at least one of interactive behaviors of capturing, raising, upgrading, and the like on the pet virtual character, but is not limited to this, and this disclosure does not limit this.

In some aspects, the pet virtual character can assist the virtual character in at least one of interactive behaviors of collecting, combating, changing land parcels, and the like, but is not limited to this, and this disclosure does not limit this.

Operation 504: In response to a touch selection operation on the control corresponding to the container prop, display an aiming joystick corresponding to the selected container prop and display an aiming front sight. For example, in response to a touch selection operation corresponding to selecting one of the first container prop or the second container prop, an aiming interface corresponding to the selected one of the first container prop and the second container prop is displayed and an aiming sight is displayed.

The aiming joystick is configured to control the aiming location indicated by the aiming front sight.

The aiming front sight is configured to assist the virtual character in aiming at the aiming location.

For example, taking the throwing of a virtual prop as an example, the master virtual character aims the aiming front sight at a location A. Then, after being thrown, the virtual prop falls at the location A, or the virtual prop falls near the location A.

For example, in response to a touch selection operation on the control corresponding to the container prop in the list control, the terminal displays an aiming joystick corresponding to the selected container prop and displays an aiming front sight.

Operation 506: In response to a touch aiming operation on the aiming joystick, display the aiming front sight whose aiming location is changed. For example, in response to a touch aiming operation on the aiming interface, a position of the displayed aiming sight is adjusted.

For example, in response to the touch aiming operation on the aiming joystick, the terminal displays the aiming front sight whose aiming location is changed, that is, changes the aiming location of the aiming front sight by controlling the aiming joystick, thereby changing the throwing direction.

In some aspects, the touch aiming operation on the aiming joystick includes at least one of dragging the aiming joystick, clicking on the aiming joystick, and double-clicking on the aiming joystick, but is not limited to this and is not specifically limited in the aspects of this disclosure.

In a possible implementation, the terminal displays a throwing button and an aiming front sight in response to a selection operation in the list control; quickly throws the container prop by clicking on the throwing button; and switches the throwing button to the aiming joystick by long-pressing the throwing button, and changes the aiming location of the aiming front sight by controlling the aiming joystick, thereby changing the throwing direction.

Operation 508: In response to a touch throwing operation and that the selected container prop is the first container prop, display the thrown first pet virtual character. For example, when the first container prop is selected, throwing the first pet virtual character is displayed in response to a touch throwing operation.

The first pet virtual character refers to a pet virtual character belonging to the master virtual character. The first pet virtual character is configured to interact with the virtual world.

The first container prop is configured to load the first pet virtual character.

Illustratively, the throwing method corresponding to the throwing operation includes at least one of high throwing, low throwing, and wall collision rebounding of the container prop. This disclosure is not limited to this, that is, the master virtual character can throw the container prop through at least one of high throwing, low throwing, and wall collision rebounding, but is not limited to this, and the aspects of this disclosure do not specifically limit this.

In some aspects, that the master virtual character throws a container prop in a high throwing manner means that the master virtual character throws the container prop upward, that is, the initial throwing direction of the container prop is upward. That the master virtual character throws a container prop in a low throwing manner means that the master virtual character throws the container prop downward, that is, the initial throwing direction of the container prop is downward. That the master virtual character throws a container prop in a wall collision rebounding manner means that the master virtual character throws a container prop toward an obstacle. That is, the initial throwing direction of the container prop is toward the collision surface of the obstacle. After hitting the obstacle, the container prop rebounds and changes the direction.

For example, in response to the touch throwing operation and that the selected container prop is the first container prop that contains the first pet virtual character, after the first container prop that contains the first pet virtual character is thrown and hits the ground, the terminal displays the first pet virtual character in the first container prop at the landing point.

In some aspects, a manner of displaying the first pet virtual character in the first container prop at the landing point is at least one of the following: when the first container prop hits the ground, the first container prop changes to appear as the first pet virtual character; or after the first container prop hits the ground, the first container prop cracks to appear as the first pet virtual character within a time threshold; or in the process in which the first container prop is thrown, the first container prop changes to appear as the first pet virtual character, that is, the first container prop appears as the first pet virtual character before hitting the ground, but is not limited to this and is not specifically limited in the aspects of this disclosure.

Operation 510: In response to the touch throwing operation and that the selected container prop is the second container prop, display the thrown second container prop. For example, when the second container prop is selected, throwing the second container prop is displayed in response to a touch throwing operation.

The second container prop is used to capture the second pet virtual character.

The second pet virtual character refers to a pet virtual character without an owner in the virtual environment.

For example, the terminal responds to the throwing operation and the selected container prop is the second container prop that does not contain the first pet virtual character, that is, the selected container prop is an empty container prop. After the second container prop that does not contain the first pet virtual character is thrown, the second container prop captures the second pet virtual character within an area. For example, when the second pet virtual character is located within the capture range of the second container prop, the second container prop captures the second pet virtual character.

To sum up, in the method provided by this aspect, a list control is displayed, in response to a touch selection operation on the list control, an aiming joystick corresponding to a selected container prop is displayed and an aiming front sight is displayed; in response to a touch aiming operation on the aiming joystick, the aiming front sight whose aiming location is changed is displayed; the thrown first pet virtual character is displayed in response to a touch throwing operation and that the selected container prop is the first container prop; and the thrown second container prop is displayed in response to the touch throwing operation and that the selected container prop is the second container prop. This disclosure provides a new human-computer interaction method based on virtual world. Selection and throwing operations of pet virtual characters are performed through the touch control on the touch screen, to implement touch-based pet capture and release. In addition, the interactive behavior between the pet virtual character and the virtual world is implemented based on the thrown pet virtual character. This assists the user to understand the pet virtual character faster through the interactive behavior between the pet virtual character and the virtual world, improves the efficiency of human-computer interaction, and enhances the user experience.

FIG. 6 is a flowchart of human-computer interaction based on virtual world according to an exemplary aspect of this disclosure. The method may be executed by a terminal in the system as shown in FIG. 4 or by a client on the terminal. This method includes:

Operation 602: Display a list control.

A control corresponding to at least one first container prop that contains a first pet virtual character, and/or a control corresponding to at least one second container prop that does not contain a pet virtual character are displayed in the list control. That is, the list control includes a control corresponding to at least one container prop, and the at least one container prop including a first container prop that contains a first pet virtual character, and/or a second container prop that does not contain a pet virtual character. For example, the first container prop and the second container prop are located in the same list control. Alternatively, the first container prop and the second container prop are located in different list controls. The first container prop includes one or more props. The second container prop includes one or more props.

Pet virtual characters refer to movable objects in the virtual world.

For example, the container prop is selected by triggering a control corresponding to the container prop in the list control.

In some aspects, the touch selection operation corresponding to the list control includes at least one of long press, single click, double click, sliding operation, and circle drawing operation, but is not limited to this and is not limited in the aspects of the present disclosure.

In a possible implementation, a first list control is displayed on the left side of a user interface in a listing manner, where the first list control includes a control corresponding to at least one first container prop; and/or a second list control is displayed on the lower side of the user interface in an overlay manner, where the second list control includes a control corresponding to at least one second container prop.

The listing manner refers to sequentially displaying corresponding identifiers of the container props according to a listing rule. Taking the arrangement of 6 first container props in the listing manner as an example, identifiers corresponding to the 6 first container props are displayed in a first list.

In some aspects, the listing rule includes at least one of the following rules, but is not limited to:
randomly list container props;
list container props according to their attributes;
list container props according to levels of pet virtual characters in the container props; and
list container props according to their levels.

The overlay manner refers to displaying the identifiers corresponding to the container props in an overlapping manner. For example, if identifiers corresponding to 6 first container props are displayed in an overlay manner, one overlapping identifier is displayed on the user interface, and by triggering the overlapping identifier, the identifiers corresponding to the 6 first container props are expanded and displayed.

In a possible implementation, in response to a triggering operation on the control corresponding to the first container prop, the terminal displays a selection identifier in a first direction of the control corresponding to the first pet virtual character; and in response to a triggering operation on the control corresponding to the second container prop, the terminal displays a selection identifier in a second direction of the control corresponding to the second container prop; where the first direction is opposite to the second direction.

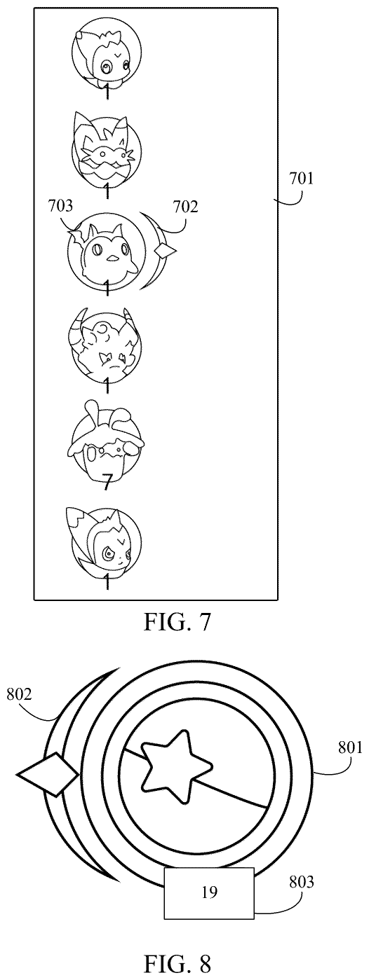

For example, FIG. 7 is a schematic diagram of the first container prop in the list control. Controls corresponding to first container props 703 that contain 6 first pet virtual characters are displayed in a listing manner in the list control 701. The first pet virtual character in the first container prop 703 is selected by triggering the control corresponding to the first container prop 703. After the selection of the first pet virtual character is completed, a selection identifier 702 is displayed on the right side of the control corresponding to the first container prop 703. The selection identifier 702 is used to indicate that the first pet virtual character in the first container prop 703 has been selected.

For example, FIG. 8 is a schematic diagram of the second container prop in the list control. The control corresponding to at least one second container prop 801 is displayed in an overlay manner in the list control, and a quantity identifier 803 of the second container prop 801 is displayed below the control corresponding to the second container prop 801. The quantity identifier 803 is used to represent the quantity of second container props 801 owned by the master virtual character. The second container prop 801 is controlled by triggering the control corresponding to the second container prop 801. After the selection of the second container prop 801 is completed, a selection identifier 802 is displayed on the left side of the control corresponding to the second container prop 801. The selection identifier 802 is used to indicate that the second container prop 801 has been selected.

Operation 604: In response to a touch selection operation on the control corresponding to the container prop, display an aiming joystick corresponding to the selected container prop and display an aiming front sight having an interactive style.

The aiming joystick is configured to control the aiming location indicated by the aiming front sight.

The aiming front sight is configured to assist the virtual character in aiming at the aiming location.

For example, in response to the touch selection operation on the list control, the terminal displays the aiming joystick corresponding to the selected container prop and the aiming front sight having an interactive style, and changes the aiming location of the aiming front sight by controlling the aiming joystick, to change the throwing direction.

For example, the aiming joystick is displayed on the user interface in a combined manner, where the aiming joystick includes a direction compass and a joystick button, and a display style of the joystick button corresponds to the selected container prop.

For example, in response to selecting the second container prop on the list control, the terminal displays a direction compass and a joystick button having the style of the second container prop on the user interface.

A display style of the aiming front sight having the interactive style is related to a virtual aiming object located at the aiming location.

A virtual aiming object refers to an object that the aiming front sight aims at in the virtual world.

In some aspects, the virtual aiming object is at least one of the second pet virtual character, the third pet virtual character, virtual props, virtual crystals, virtual collection objects, virtual treasure boxes, virtual potential energy mechanisms, virtual grassland, and virtual water pools, but is not limited to this and is not specifically limited in the aspects of this disclosure.

The aiming front sight having an interactive style includes at least one of the following cases:

Case one: aiming front sight having a first interactive style.

For example, in response to that the selected container prop is the second container prop and the aiming front sight aims at the second pet virtual character, the terminal displays the aiming front sight having a first interactive style. The first interactive style is used to indicate that the thrown second container prop is used to capture the second pet virtual character.

In some aspects, in response to that the selected container prop is the second container prop and the aiming front sight aims at the second pet virtual character, the terminal displays the aiming front sight having a first interactive style and a capture success rate identifier of the second pet virtual character.

The capture success rate identifier is used to identify a success rate of the second container prop in capturing the second pet virtual character.

In some aspects, in a case that the second container prop successfully captures the second pet virtual character, the second container prop that successfully captures the second pet virtual character is displayed.

For example, when the second container prop successfully captures the second pet virtual character, the second container prop that successfully captures the second pet virtual character is displayed in a pop-up manner.

In some aspects, in a case that the second container prop unsuccessfully captures the second pet virtual character, the second container prop that unsuccessfully captures the second pet virtual character is displayed.

For example, in a case that the second container prop unsuccessfully captures the second pet virtual character, the second container prop that unsuccessfully captures the second pet virtual character is displayed in a scrolling manner.

In some aspects, in a case that the throwing location and/or the throwing timing of the second container prop is incorrect, the second container prop fails to capture the second pet virtual character, and a prompt indicating that the capture fails is displayed.

In some aspects, in a case that the throwing location and the throwing timing of the second container prop are both correct, but the level and/or blood tank value and/or energy value of the master virtual character is insufficient, the second container prop fails to capture the second pet virtual character, and a prompt indicating that the capture failed is displayed.

In some aspects, in a case that the throwing location and the throwing timing of the second container prop are both correct, and the level and/or blood tank value and/or energy value of the master virtual character is sufficient, the second container prop successfully captures the second pet virtual character, and a capture success prompt, rewards for successful capture (such as experience points and newly acquired skills), and an attribute of the captured second pet virtual character (such as a name, a gender, a height, a weight, a number, a skill, rarity, and a personality trait) are displayed.

Case two: aiming front sight having a second interactive style.

For example, in response to that the selected container prop is the first container prop and the aiming front sight aims at the virtual collection object, the terminal displays the aiming front sight having the second interactive style. The second interactive style is used to indicate that the thrown first pet virtual character is configured for collecting the virtual collection object.

Case three: aiming front sight having a third interactive style.

For example, in response to that the selected container prop is the first container prop and the aiming front sight aims at the third pet virtual character, the terminal displays the aiming front sight having the third interactive style. The third interactive style is used to indicate that the thrown first pet virtual character is configured for combating with the third pet virtual character.

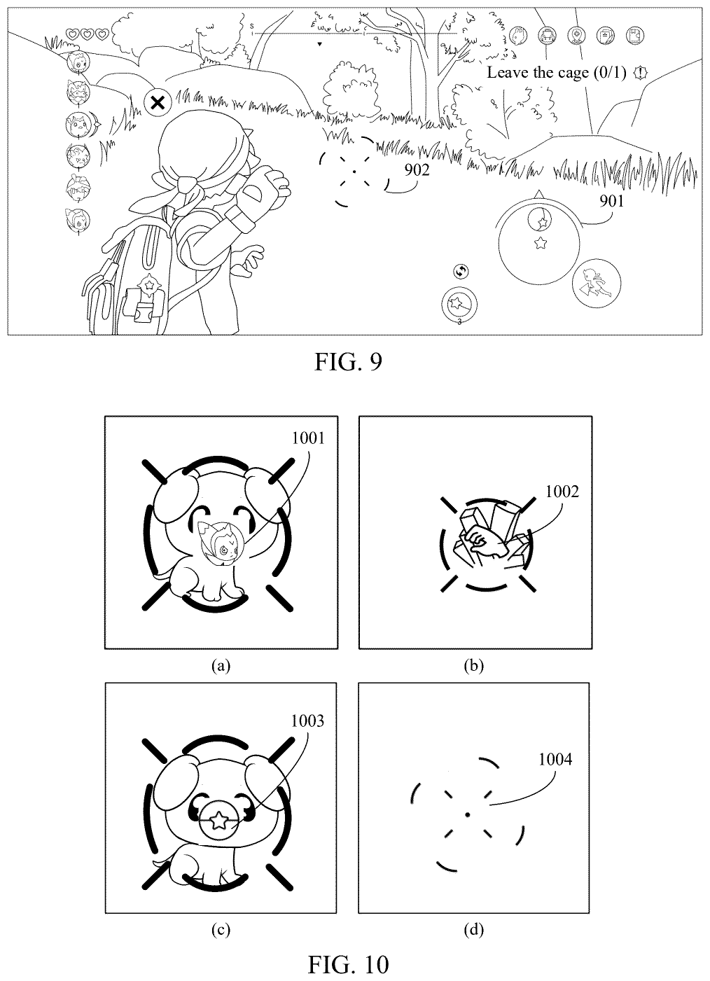

For example, FIG. 9 is the schematic diagram of throwing by the master virtual character. In response to a touch selection operation on a control corresponding to a container prop in the list control, the terminal displays an aiming joystick 901 corresponding to the selected container prop and displays an aiming front sight 902. FIG. 10 is a schematic diagram of the display style of the aiming front sight having the interactive style. As shown in (a) of FIG. 10, in the case that the selected container prop is the first container prop and the aiming front sight aims at the third pet virtual character, the aiming front sight having a “pet avatar” style 1001 is displayed, where the aiming front sight having the “pet avatar” style 1001 is used to indicate that the thrown first pet virtual character is used to engage in turn-based combats with the third pet virtual character. As shown in (b) of FIG. 10, in a case that the selected container prop is the first container prop and the aiming front sight aims at the virtual collection object, the aiming front sight having a “palm” style 1002 is displayed, where the aiming front sight having the “palm” style 1002 is used to indicate that the thrown first pet virtual character is used to collect virtual collection objects. As shown in (c) of FIG. 10, in a case that the selected container prop is the second container prop and the aiming front sight aims at the second pet virtual character, the aiming front sight having a “container prop” style 1003 is displayed, where the aiming front sight having the “container prop” style 1003 is used to indicate that the thrown second container prop is used to capture the second pet virtual character. As shown in (d) of FIG. 10, in a case that there is no virtual aiming object at the aiming location of the aiming front sight, the aiming front sight appears in a “cross star” style 1004.

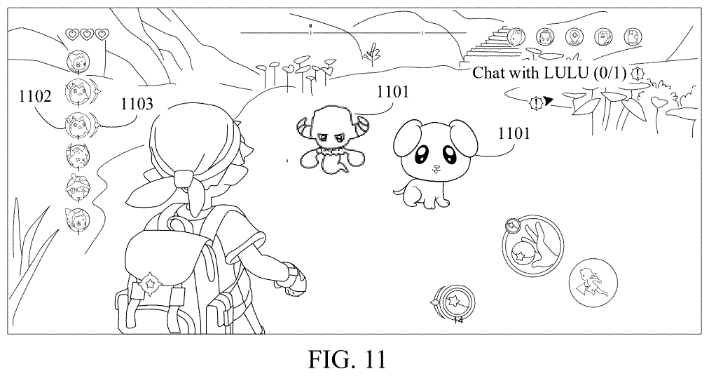

For example, FIG. 11 is a schematic diagram in which the master virtual character releases the first pet virtual character. In response to the touch throwing operation and that the selected container prop is the first container prop 1102 that contains the first pet virtual character 1101, the terminal displays the thrown first pet virtual character 1101. After the first pet virtual character 1101 is thrown, the first pet virtual character 1101 is displayed in the virtual environment, and at the same time, a selection identifier 1103 is displayed on the right side of the first container prop 1102 in the pet virtual character selection area. For example, multiple first pet virtual characters can be released in the virtual environment, so that the multiple first pet virtual characters can exist in the virtual environment at the same time. For example, multiple first pet virtual characters may be released to the virtual environment at the same time, for example, multiple first container props are thrown at the same time to release multiple first pet virtual characters to the virtual environment.

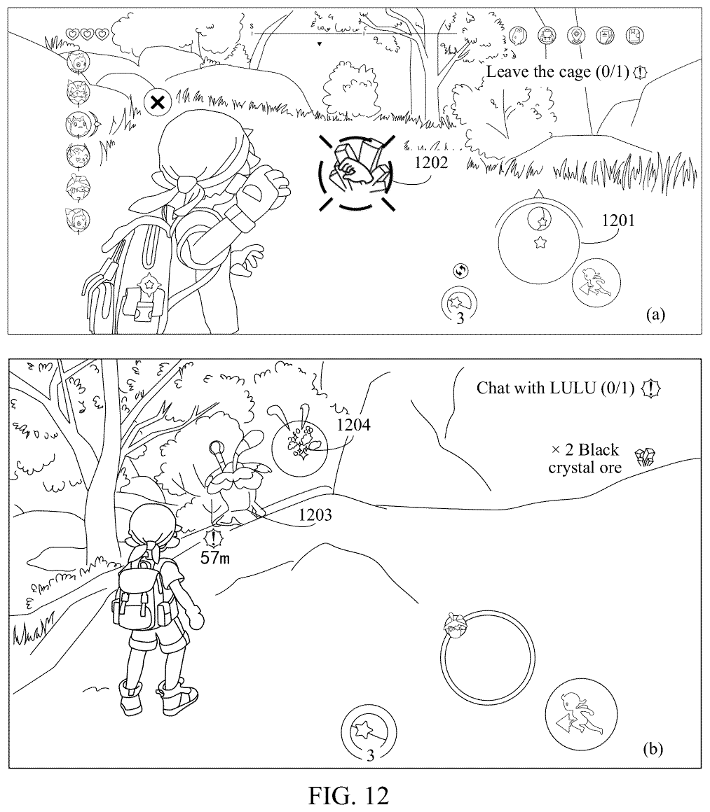

For example, FIG. 12 is a schematic diagram in which the first pet virtual character collects a virtual collection object. As shown in (a) of FIG. 12, in response to the touch selection operation on the first container prop that contains the first pet virtual character in the list control, the terminal displays the aiming joystick 1201 corresponding to the selected first container prop and the aiming front sight having a “palm” style 1202. As shown in (b) of FIG. 12, after the first pet virtual character 1203 is thrown, that the first pet virtual character 1203 collects a virtual collection object 1204 is displayed in the virtual environment, for example, the first pet virtual character 1203 collects black crystal ore.

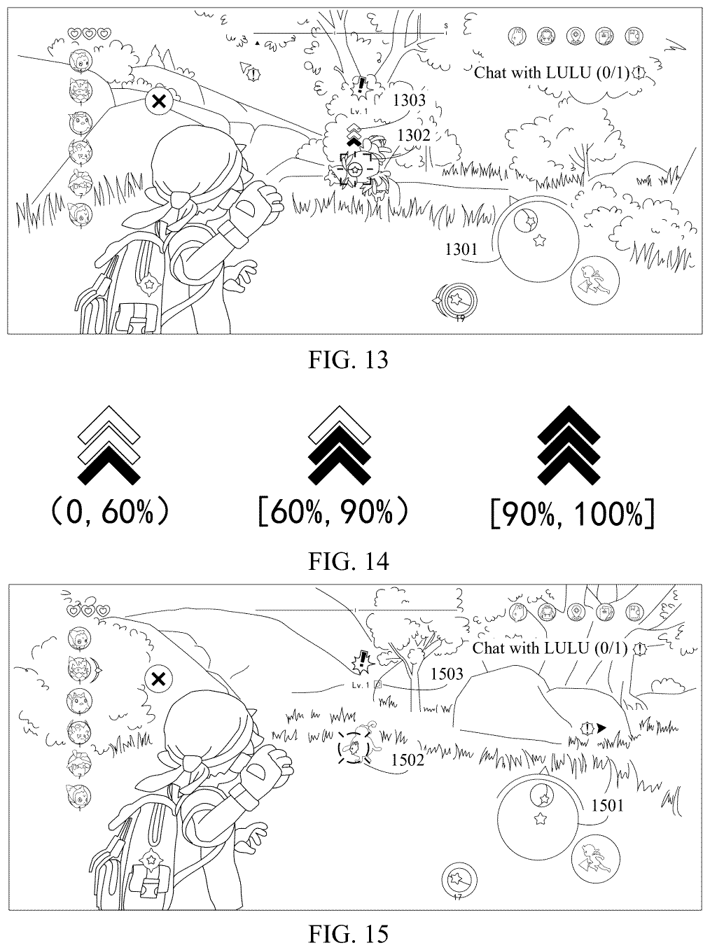

For example, FIG. 13 is a schematic diagram of capturing the second pet virtual character. In response to the touch selection operation on the second container prop, the terminal displays an aiming joystick 1301 corresponding to the selected second container prop and an aiming front sight having a “container prop” style 1302, and displays a capture success rate identifier 1303 of the second pet virtual character. The capture success rate identifier 1303 is used to identify a success rate of the second container prop in capturing the second pet virtual character. For example, FIG. 14 is a schematic diagram of the capture success rate identifier. A progress bar displays the success rate of the second container prop in capturing the second pet virtual character. One bar of progress is used to represent that the success rate of the second container prop in capturing the second pet virtual character is 0-60%. Two bars of progress are used to represent that the success rate of the second container prop in capturing the second pet virtual character is 60%-90%. Three bars of progress are used to represent that the success rate of the second container prop in capturing the second pet virtual character is 90%-100%.

For example, in a case that the throwing location and/or the throwing timing of the second container prop is incorrect, the capture success rate identifier of the second container prop in capturing the second pet virtual character is 0, and a prompt indicating that the capture fails is displayed.

In a case that the throwing location and the throwing timing of the second container prop are both correct, but the level or blood tank value or energy value of the master virtual character is insufficient, the capture success rate identifier of the second container prop in capturing the second pet virtual character is 40%.

In a case that the throwing location and the throwing timing of the second container prop are both correct, and the level or blood tank value or energy value of the master virtual character is sufficient, the capture success rate identifier of the second container prop in capturing the second pet virtual character is 95%. In a case that the second pet virtual character is successfully captured, a capture success prompt, rewards for successful capture (such as experience points and newly acquired skills), and an attribute of the captured second pet virtual character (such as a name, a type, a height, a weight, a number, a skill, rarity, and a personality trait) are displayed.

In a possible implementation, the display of the capture success rate identifier is related to the capture threshold corresponding to the pet virtual character. When the capture threshold corresponding to the pet virtual character is larger, it is easier to capture the pet virtual character.

In some aspects, the pet virtual character corresponds to the initial value of the capture threshold. In some aspects, the initial value of the capture threshold is related to a first factor, and the first factor includes at least one of the following factors:
pet type and/or pet level of the pet virtual character;
prop type and/or prop level of the container prop used in the capture operation;
number of times the master virtual character captures the pet virtual character in history;
number of times the master virtual character captures the same type of pet virtual character in history;
whether the pet virtual character has discovered the master virtual character;
distance between the master virtual character and the pet virtual character;
personality matching degree between the master virtual character and the pet virtual character; and
gender matching degree between the main virtual character and the pet virtual character.

In some aspects, the pet type of the pet virtual character includes but is not limited to bird, insect, large animal, small animal, and the like. The pet level includes but is not limited to elementary, intermediate, advanced, and the like. The initial value of the capture threshold of the pet virtual character is related to the pet type and/or pet level of the pet virtual character. When the pet type of the pet virtual character is rarer and/or the pet level of the pet virtual character is higher, it is more difficult to capture the pet virtual character, and the corresponding initial value of the capture threshold is smaller.

In some aspects, the prop type of the container prop includes but is not limited to ordinary prop, intermediate prop, advanced prop, and the like. The prop level includes but is not limited to elementary, intermediate, advanced, and the like. When the container prop used in the capture operation has a more advanced prop type and/or higher prop level, it is easier to capture the pet virtual character, and the corresponding initial value of the capture threshold is larger.

In some aspects, the initial value of the capture threshold is related to the number of times the master virtual character captures the pet virtual character in history. The number of times the master virtual character captures the pet virtual character in history may be positively correlated with the initial value of the capture threshold. For example, when the number of historical captures is larger, it indicates that it is easier for the master virtual character to capture the pet virtual character, and the corresponding initial value of the capture threshold is larger.

In some aspects, the initial value of the capture threshold is related to the number of times the master virtual character captures the same type of pet virtual character in history. The number of times the master virtual character captures the same type of pet virtual character in history may be positively correlated with the initial value of the capture threshold. For example, when the number of historical captures of the same type of pet virtual character is larger, it indicates that the master virtual character is better at capturing this type of pet virtual character, that is, the initial value of the capture threshold corresponding to this type of pet virtual character is larger.

In some aspects, the initial value of the capture threshold is also related to whether the pet virtual character discovers the master virtual character. When the pet virtual character has not discovered the master virtual character, the master virtual character may go to the blind spot of the pet virtual character and capture the pet virtual character directly. In this case, the master virtual character needs to adopt a capture strategy, and the capture success rate can be relatively high without a combat. That is, when the pet virtual character has not discovered the master virtual character, the corresponding initial value of the capture threshold is larger.

In some aspects, the distance between the master virtual character and the pet virtual character can affect the capture threshold, and the distance can be positively correlated with the initial value of the capture threshold. For example, when the distance between the master virtual character and the pet virtual character is shorter, the skill release of the master virtual character is more targeted. In this case, the capture success rate of the pet virtual character is higher, that is, the corresponding initial value of the capture threshold is larger.

In some aspects, the initial value of the capture threshold is also related to the personality matching degree between the master virtual character and the pet virtual character. The personality matching degree can be positively correlated with the initial value of the capture threshold. Based on the personality attribute of the pet virtual character, each pet virtual character has a personality of the master virtual character that the pet virtual character likes or dislikes. For example, a pet virtual character with a bellicose personality prefers a master virtual character with a belligerent personality, and the personality matching degree between the two characters is relatively high. When the personality matching degree between the master virtual character and the pet virtual character is higher, it is easier to capture the pet virtual character, that is, the initial value of the capture threshold is larger.

In some aspects, the initial value of the capture threshold is also related to the gender matching degree between the master virtual character and the pet virtual character. The gender matching degree can be positively correlated with the initial value of the capture threshold. Based on the gender attribute of the pet virtual character, each pet virtual character has a gender of the master virtual character that the pet virtual character likes or dislikes. When the gender matching degree between the master virtual character and the pet virtual character is higher, it is easier to capture the pet virtual character, that is, the initial value of the capture threshold is larger.

The above values are relative values, and the specific value needs to be determined based on the actual case. The initial value of the capture threshold of the pet virtual character is related to the first factor. However, for a determined first factor, whether the initial value of the capture threshold of the pet virtual character caused by the first factor is large or small further needs to be set according to the specific pet virtual character.

For example, the first factor is the prop type of the container prop. When one pet virtual character uses a more advanced container prop, the capture success rate is higher, that is, the corresponding initial value of the capture threshold is larger. When another pet virtual character uses a more advanced container prop, the capture success rate is lower, that is, the corresponding initial value of the capture threshold is smaller. That is, whether the initial value of the capture threshold of the pet virtual character caused by the first factor is large or small further needs to be set according to the specific pet virtual character.

In this aspect, the capture threshold of the pet virtual character has an initial value, and the initial value of the capture threshold is related to the first factor, so that the initial value of the capture threshold of the pet virtual character may be adaptively adjusted based on information such as the operation or attribute of the master virtual character, which greatly enriches the capture scenes of pet virtual characters. Furthermore, different master virtual characters can also adaptively adopt different capture strategies based on the initial value of the capture threshold of the pet virtual character, which can improve the efficiency of human-computer interaction and improve the player gaming experience.

For example, FIG. 15 is a schematic diagram of throwing the first pet virtual character to perform turn-based combat. In response to the touch selection operation on the first container prop that contains the first pet virtual character in the list control, the terminal displays the aiming joystick 1501 corresponding to the selected first container prop and the aiming front sight having a “container prop” style 1502. At the same time, role information 1503 of the third pet virtual character is displayed. The role information 1503 is used to represent attribute information, level information, and category information of the third pet virtual character, thereby assisting the user in selecting a suitable first pet virtual character.

Operation 606: In response to a touch aiming operation on the aiming joystick, display the aiming front sight whose aiming location is changed.

For example, in response to the touch aiming operation on the aiming joystick, the terminal displays the aiming front sight whose aiming location is changed, that is, changes the aiming location of the aiming front sight by controlling the aiming joystick, thereby changing the throwing direction.

In some aspects, the touch aiming operation on the aiming joystick includes at least one of dragging the aiming joystick, clicking on the aiming joystick, and double-clicking on the aiming joystick, but is not limited to this and is not specifically limited in the aspects of this disclosure.

In a possible implementation, the terminal displays a throwing button and an aiming front sight in response to a selection operation in the list control; quickly throws the container prop by clicking on the throwing button; and switches the throwing button to the aiming joystick by long-pressing the throwing button, and changes the aiming location of the aiming front sight by controlling the aiming joystick, thereby changing the throwing direction.

Operation 608: In response to a throwing operation and that the selected container prop is the first container prop, display the thrown first pet virtual character.

The first pet virtual character refers to a pet virtual character belonging to the master virtual character. The first pet virtual character is configured to interact with the virtual world.

The first container prop is configured to load the first pet virtual character.

Illustratively, the throwing method corresponding to the throwing operation includes at least one of high throwing, low throwing, and wall collision rebounding of the container prop. This disclosure is not limited to this, that is, the master virtual character can throw the container prop through at least one of high throwing, low throwing, and wall collision rebounding, but is not limited to this, and the aspects of this disclosure do not specifically limit this.

In some aspects, that the master virtual character throws a container prop in a high throwing manner means that the master virtual character throws the container prop upward, that is, the initial throwing direction of the container prop is upward. That the master virtual character throws a container prop in a low throwing manner means that the master virtual character throws the container prop downward, that is, the initial throwing direction of the container prop is downward. That the master virtual character throws a container prop in a wall collision rebounding manner means that the master virtual character throws a container prop toward an obstacle. That is, the initial throwing direction of the container prop is toward the collision surface of the obstacle. After hitting the obstacle, the container prop rebounds and changes the direction.

For example, in response to the throwing operation and the selected container prop is the first container prop that contains the first pet virtual character, after the first container prop that contains the first pet virtual character is thrown and hits the ground, the terminal displays the first pet virtual character in the first container prop at the landing point.

In a possible implementation, in response to the attribute of the first pet virtual character, the terminal displays the interaction behavior between the first pet virtual character and the virtual environment at the location of the first pet virtual character. That is, the terminal displays an interactive behavior between the first pet virtual character and the virtual environment at a location of the first pet virtual character, where the interactive behavior is related to an attribute of the first pet virtual character.

The attribute of the first pet virtual character refers to an element or an identifier that is carried by the first pet virtual character and that affects the combat.

In some aspects, the attribute of the first pet virtual character includes at least one of grass attribute, fire attribute, water attribute, stone attribute, ice attribute, electric attribute, poison attribute, light attribute, ghost attribute, demon attribute, ordinary attribute, martial attribute, cute attribute, fantasy attribute, insect attribute, wing attribute, dragon attribute, and mechanical attribute, but is not limited to this, and the aspects of the present disclosure do not specifically limit this.

For example, the ice attribute and the fire attribute restrain each other. That is, when the first pet virtual character with the ice attribute engages in a turn-based combat with the third pet virtual character with the fire attribute, a damage value of the first pet virtual character with the ice attribute against the third pet virtual character with the fire attribute is higher.

For example, the terminal changes, based on the attribute of the first pet virtual character, the attribute of the land parcel where the first pet virtual character is located in the virtual environment.

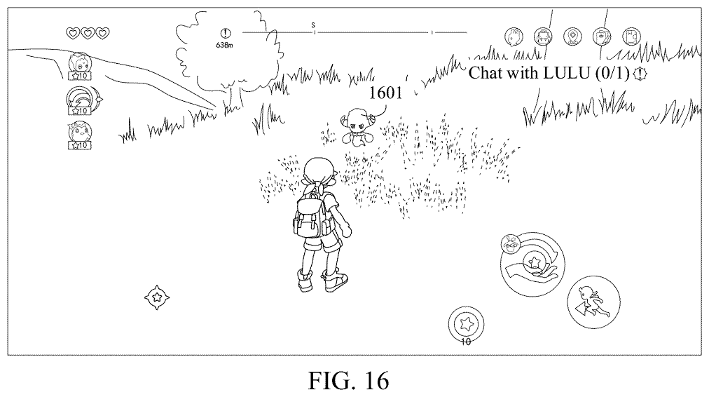

For example, FIG. 16 is a schematic diagram in which the first pet virtual character interacts with the virtual environment. The terminal responds to the throwing operation and the selected container prop is the first container prop that contains the first pet virtual character 1601. After the first container prop that contains the first pet virtual character 1601 is thrown to the ground, based on the fire attribute of the first pet virtual character 1601, the land parcel where the first pet virtual character 1601 lands is burned.

In some aspects, after the first container prop that contains the first pet virtual character 1601 is thrown to the ground, based on the fire attribute of the first pet virtual character 1601, the land parcel within the first range of the landing point of the first pet virtual character 1601 is burned.

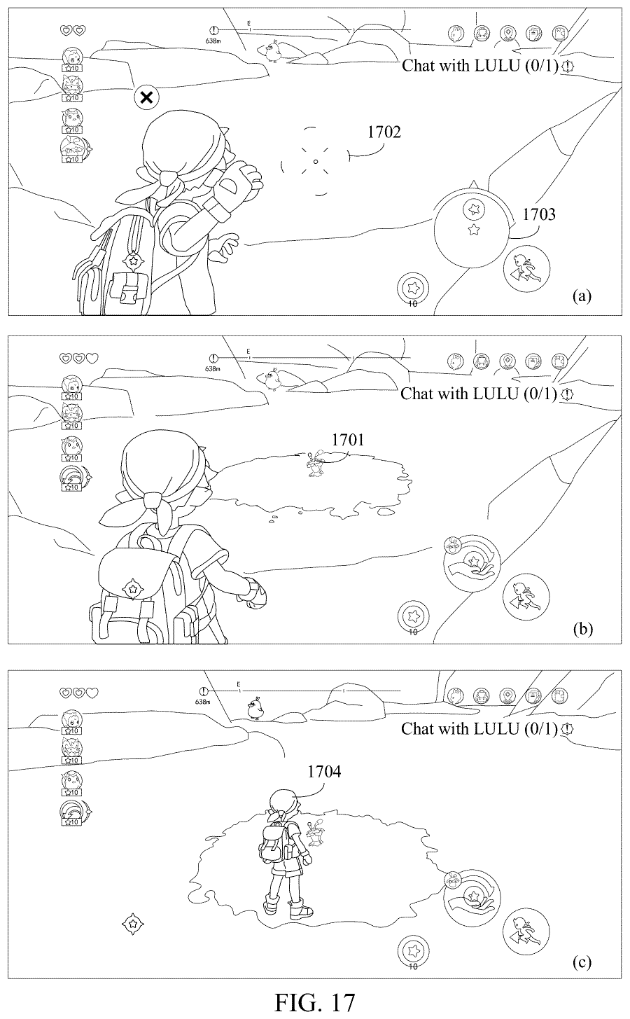

For example, FIG. 17 is a schematic diagram in which the first pet virtual character interacts with the virtual environment. As shown in (a) of FIG. 17, in response to the throwing operation and that the selected container prop is the first container prop that contains the first pet virtual character 1701, the terminal displays an aiming joystick 1703 corresponding to the selected first container prop and an aiming front sight 1702. As shown in (b) of FIG. 17, when the first container prop that contains the first pet virtual character 1701 aims at the water surface and is thrown onto the water surface, based on the ice attribute of the first pet virtual character 1701, the water surface where the first pet virtual character 1701 is located is frozen. As shown in (c) of FIG. 17, after the water surface where the first pet virtual character 1701 is located is frozen, the master virtual character 1704 can walk on the frozen water surface.

In some aspects, after the first container prop that contains the first pet virtual character 1701 is thrown to the ground, based on the ice attribute of the first pet virtual character 1701, the water surface within the second range of the landing point of the first pet virtual character 1701 is frozen.

For example, the terminal opens or closes a virtual treasure box at the location of the first pet virtual character based on the attribute of the first pet virtual character, where the virtual treasure box is used to place a virtual prop.

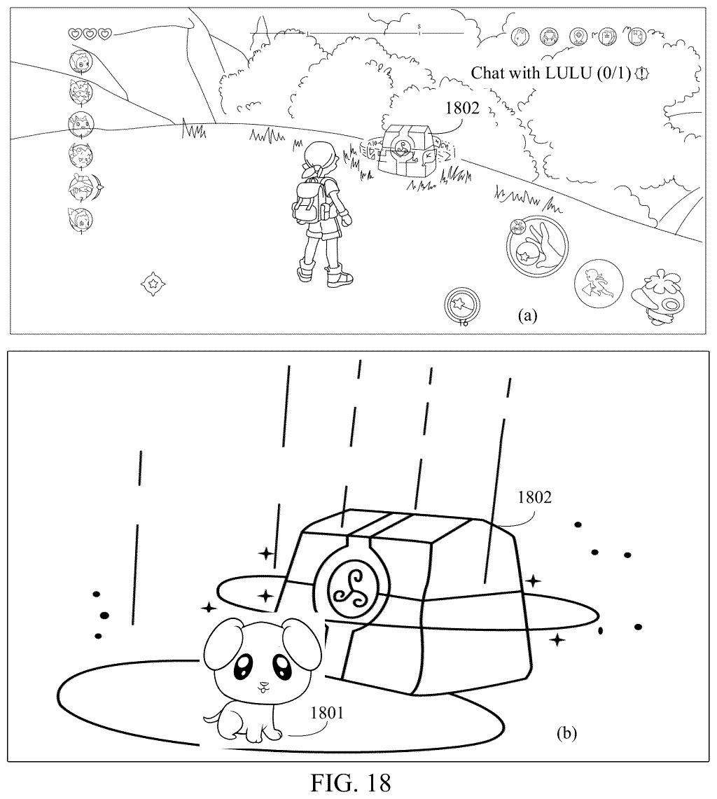

For example, FIG. 18 is a schematic diagram in which the first pet virtual character interacts with the virtual environment. As shown in (a) of FIG. 18, in response to the throwing operation and that the selected container prop is the first container prop that contains a first pet virtual character 1801, the terminal throws the first container prop that contains the first pet virtual character 1801 around a virtual treasure box 1802 in the virtual environment. As shown in (b) of FIG. 18, when the attribute of the first pet virtual character 1801 is the same as the attribute of the virtual treasure box 1802, the virtual treasure box 1802 is opened and special-effect fireworks are displayed at the same time.

For example, the terminal triggers the virtual potential energy mechanism in the virtual environment based on the attribute of the first pet virtual character. The virtual potential energy mechanism is configured for changing an attribute intensity value of a pet virtual character within a potential energy range of the virtual potential energy mechanism.

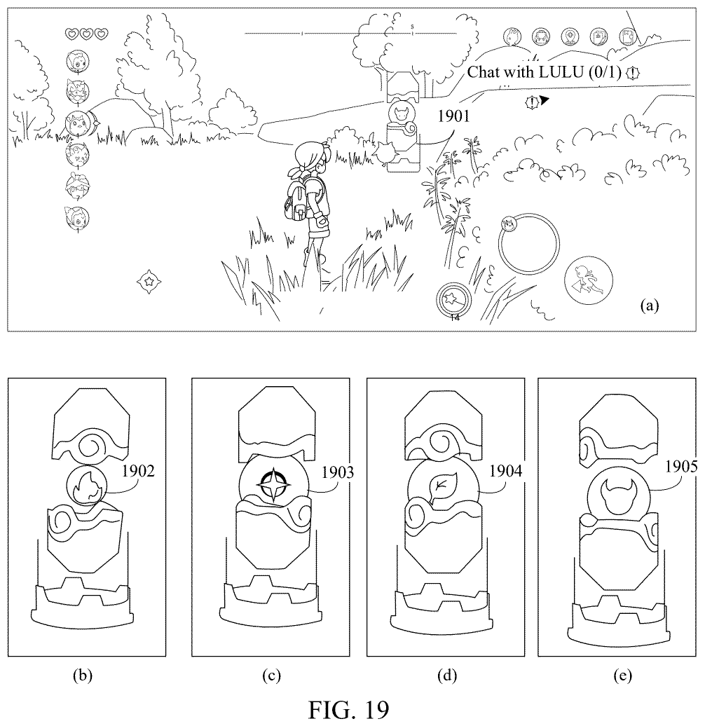

For example, FIG. 19 is a schematic diagram in which the first pet virtual character interacts with the virtual environment. As shown in (a) of FIG. 19, a virtual potential energy mechanism 1901 is displayed in the virtual environment, and in response to the throwing operation and that the selected container prop is the first container prop that contains a first pet virtual character, the terminal throws the first container prop that contains the first pet virtual character around the virtual potential energy mechanism 1901 in the virtual environment. When the attribute of the first pet virtual character is the same as the attribute of the virtual potential energy mechanism 1901, the virtual potential energy mechanism 1901 is triggered. The triggered virtual potential energy mechanism 1901 changes an attribute intensity value of a pet virtual character within a potential energy range of the virtual potential energy mechanism. As shown in (b) of FIG. 19, the attribute identifier of the virtual potential energy mechanism 1901 is a fire identifier 1902, that is, the virtual potential energy mechanism 1901 needs to be triggered by the first pet virtual character with the fire attribute. As shown in (c) of FIG. 19, the attribute identifier of the virtual potential energy mechanism 1901 is a metal identifier 1903, that is, the virtual potential energy mechanism 1901 needs to be triggered by the first pet virtual character with the metal attribute. As shown in (d) of FIG. 19, the attribute identifier of the virtual potential energy mechanism 1901 is a wood identifier 1904, that is, the virtual potential energy mechanism 1901 needs to be triggered by the first pet virtual character with the wood attribute. As shown in (e) of FIG. 19, the attribute identifier of the virtual potential energy mechanism 1901 is a spirit identifier 1905, that is, the virtual potential energy mechanism 1901 needs to be triggered by the first pet virtual character with the spirit attribute.

The virtual potential energy mechanism changes an attribute intensity value of a pet virtual character within a potential energy range of the virtual potential energy mechanism, thus affecting the combat between pet virtual characters. For example, after the virtual potential energy mechanism with the fire attribute is activated, when the pet virtual character with the fire attribute and the pet virtual character with the wood attribute combat within the potential energy range of the virtual potential energy mechanism, the virtual potential energy mechanism with the fire attribute strengthens the attribute intensity value of the pet virtual character with the fire attribute, and restrains the attribute intensity value of the pet virtual character with the wood attribute.

For example, a correspondence table of the interaction between attributes is shown in Table 1. Abbreviations are used to indicate attributes in the table, for example, “grass” represents “grass attribute”. Each row represents the attacker, and each column represents the attacked. 0.5 is used to indicate that the attribute of the attacker restrains the attribute of the attacked. On the contrary, 2 is used to indicate that the attribute of the attacker counter-restrains the attribute of the attacked. For example, if the metal attribute restrains the wood attribute, after the virtual potential energy mechanism with the metal attribute is activated, when the attacker with the metal attribute attacks the attacked with the wood attribute, the damage value doubles. When the attacker with the wood attribute attacks the attacked with the metal attribute, the damage value is halved.

TABLE 1
Correspondence table of interactive between attributes

| | Grass | Fire | Water | Stone | Ice | Electricity | Poison | Light | Ghost |
|---|---|---|---|---|---|---|---|---|---|
| Grass | 0.5 | 0.5 | 2 | 2 | 0 | 0 | 0.5 | 0 | 0 |
| Fire | 2 | 0 | 0.5 | 0.5 | 2 | 0 | 0 | 0 | 0 |
| Water | 0.5 | 2 | 0 | 2 | 0 | 0 | 0 | 0 | 0 |
| Stone | 0 | 2 | 0 | 0 | 2 | 0 | 0 | 0 | 0 |
| Ice | 2 | 0.5 | 0.5 | 0 | 0.5 | 0 | 0 | 0 | 0 |
| Electricity | 0 | 0 | 2 | 0 | 0 | 0.5 | 0 | 0 | 0 |
| Poison | 0 | 0 | 0 | 0.5 | 0 | 0 | 0.5 | 0 | 0.5 |
| Light | 0 | 0 | 0 | 0 | 0 | 0 | 0 | 0 | 2 |
| Ghost | 0 | 0 | 0 | 0 | 0 | 0 | 0 | 0.5 | 2 |
| Demon | 0 | 0 | 0 | 0 | 0 | 0 | 0 | 0.5 | 2 |
| Ordinary | 0 | 0 | 0 | 0.5 | 0 | 0 | 0 | 0 | 0 |
| Martial | 0 | 0 | 0 | 2 | 2 | 0 | 0.5 | 0 | 0 |
| Cute | 0 | 0 | 0 | 0 | 0 | 0 | 2 | 0 | 0 |
| Fantasy | | | | | | | | | |
| Insect | 2 | 0.5 | 0 | 0 | 0 | 0 | 0.5 | 0 | 0.5 |
| Wing | 2 | 0 | 0 | 0.5 | 0 | 0.5 | 0 | 0 | 0 |
| Dragon | 0 | 0 | 0 | 0 | 0 | 0 | 0 | 0 | 0 |
| Mechanical | 0 | 0.5 | 0.5 | 2 | 2 | 0.5 | 0 | 0 | 0 |

| | Demon | Ordinary | Martial | Cute | Fantasy | Insect | Wing | Dragon | Mechanical |
|---|---|---|---|---|---|---|---|---|---|
| Grass | 0 | 0 | 0 | 0 | | 0.5 | 0.5 | 0.5 | 0.5 |
| Fire | 0 | 0 | 0 | 0 | | 2 | 0 | 0.5 | 2 |
| Water | 0 | 0 | 0 | 0 | | 0 | 0 | 0.5 | 0 |
| Stone | 0 | 0 | 0.5 | 0 | | 2 | 2 | 0 | 0.5 |
| Ice | 0 | 0 | 0 | 0 | | 0 | 2 | 2 | 0.5 |
| Electricity | 0 | 0 | 0 | 0 | | 0 | 2 | 0.5 | 0 |
| Poison | 0 | 0 | 0 | 0 | | 0 | 0 | 0 | 0 |
| Light | 2 | 0 | 0 | 0 | | 0 | 0 | 0 | 0 |
| Ghost | 0.5 | 0 | 0 | 2 | | 0 | 0 | 0 | 0.5 |
| Demon | 0.5 | 0 | 0.5 | 2 | | 0 | 0 | 0 | 0.5 |
| Ordinary | 0 | 0 | 0 | 0 | | 0 | 0 | 0 | 0.5 |
| Martial | 2 | 2 | 0 | 0.5 | | 0.5 | 0.5 | 0 | 2 |
| Cute | 0 | 0 | 2 | 0.5 | | 0 | 0 | 0 | 0.5 |
| Fantasy | | | | | | | | | |
| Insect | 2 | 0 | 0.5 | 2 | | 0 | 0.5 | 0 | 0.5 |
| Wing | 0 | 0 | 2 | 0 | | 2 | 0 | 0 | 0.5 |
| Dragon | 0 | 0 | 0 | 0 | | 0 | 0 | 2 | 0.5 |
| Mechanical | 0 | 0 | 0 | 0 | | 0 | 0 | 0 | 0.5 |

Operation 610: In response to the throwing operation and that the selected container prop is the second container prop, display the thrown second container prop.

The second container prop is used to capture the second pet virtual character.

The second pet virtual character refers to a pet virtual character without an owner in the virtual environment.

For example, the terminal responds to the throwing operation and the selected container prop is the second container prop that does not contain the first pet virtual character, that is, the selected container prop is an empty container prop. After the second container prop that does not contain the first pet virtual character is thrown, the second container prop captures the second pet virtual character within an area. For example, when the second pet virtual character is located within the capture range of the second container prop, the second container prop captures the second pet virtual character.

In a possible implementation, in response to that the container prop collides with a collision surface in a throwing process, the terminal displays a collision trajectory after the container prop collides with the collision surface.

For example, in response to that an angle between a throwing direction of the container prop and the collision surface is greater than an angle threshold, the terminal displays a rebound trajectory of the container prop after the collision with the collision surface.

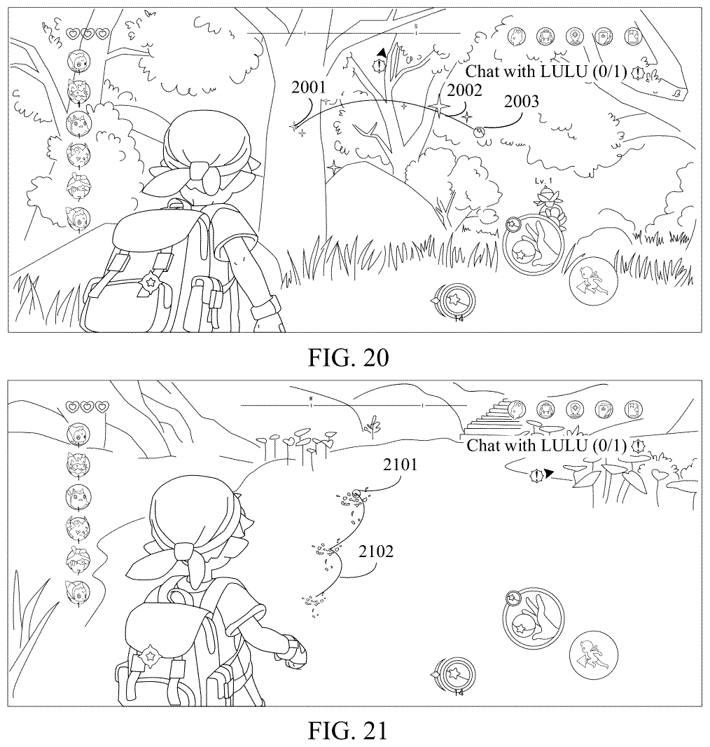

For example, FIG. 20 is a schematic diagram in which a container prop interacts with a virtual environment. In response to that the container prop 2003 collides with a collision surface 2001 in the throwing process, in a case that an angle between a throwing direction of the container prop 2003 and the collision surface 2001 is greater than an angle threshold, the terminal displays a rebound trajectory 2002 of the container prop 2003 after the collision with the collision surface 2001. For example, when the angle between the throwing direction of the container prop 2003 and the collision surface 2001 is greater than 30°, the rebound trajectory 2002 of the container prop 2003 after the collision with the tree trunk is displayed.

For example, in response to that an angle between a throwing direction of the container prop and the collision surface is less than or equal to an angle threshold, the terminal displays a continuous bouncing trajectory of the container prop continuously bouncing on the collision surface.

For example, FIG. 21 is a schematic diagram in which a container prop interacts with a virtual environment. In response to that the container prop 2101 collides with the collision surface in the throwing process, in a case that an angle between a throwing direction of the container prop 2101 and the collision surface is less than or equal to an angle threshold, the terminal displays a continuous bouncing trajectory 2102 of the container prop 2101 continuously bouncing on the collision surface. For example, in a case that the angle between the throwing direction of the container prop 2101 and the collision surface is less than or equal to 30°, a continuous bouncing trajectory 2102 of the container prop 2101 continuously bouncing on the water surface is displayed.

For example, the landing point of the thrown pet virtual prop may be any location in the virtual environment. Some places are suitable for releasing the first pet virtual character. Some places are determined as places not suitable for releasing the first pet virtual character, because there are surrounding obstacles or the release locations are not suitable for the ecology of the first pet virtual character.

When throwing a pet virtual prop, the landing point of the thrown pet virtual prop is used as the center of the circle, a fan-shaped area facing the master virtual character is selected, and several potential release points are selected evenly on the ground in this area. At the same time, the following checks are performed on each potential release point: (1) Exclude release points that block the visibility of the location of the master virtual character, that is, the master virtual character can be seen when standing on the release point. (2) Exclude release points with excessive slopes around the ground in the virtual environment, that is, a relatively flat ground is required. (3) Exclude release points with visible virtual objects above, that is, there is no obstacle around. (4) Exclude release points that are excessively close to the main virtual character. Finally, selected potential release points are sorted, and the point with the highest score is selected as the release point.

In some aspects, the principle for sorting potential release points includes at least one of the following:
the closer the potential release point is to the landing point, the better; and
the locations of the landing point, the potential release point, and the master virtual character are on the same straight line.

To sum up, in the method provided by this aspect, a list control is displayed, in response to a touch selection operation on the list control, an aiming joystick corresponding to a selected container prop is displayed and an aiming front sight is displayed; in response to a touch aiming operation on the aiming joystick, the aiming front sight whose aiming location is changed is displayed; the thrown first pet virtual character is displayed in response to a touch throwing operation and that the selected container prop is the first container prop; and the thrown second container prop is displayed in response to the touch throwing operation and that the selected container prop is the second container prop. This disclosure provides a new human-computer interaction method based on virtual world. Selection and throwing operations of pet virtual characters are performed through the touch control on the touch screen, to implement touch-based pet capture and release. In addition, the interactive behavior between the pet virtual character and the virtual world is implemented based on the thrown pet virtual character. This assists the user to understand the pet virtual character faster through the interactive behavior between the pet virtual character and the virtual world, improves the efficiency of human-computer interaction, and enhances the user experience.

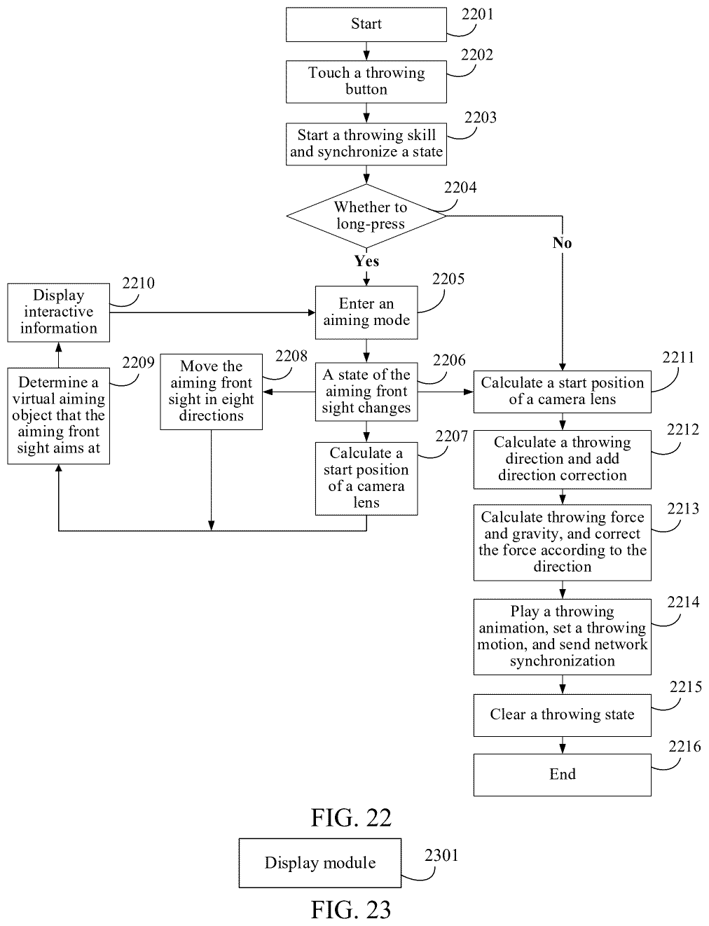

FIG. 22 is a flowchart of human-computer interaction based on virtual world according to an exemplary aspect of this disclosure. The method may be executed by a terminal in the system as shown in FIG. 4 or by a client on the terminal. This method includes:

Operation 2201: Start.

Operation 2202: Touch a throwing button.

For example, a list control is displayed on the user interface. A control corresponding to at least one first container prop that contains a first pet virtual character, and/or a control corresponding to at least one second container prop that does not contain a pet virtual character are displayed in the list control.

The container prop in the list control is touched for selection, and throwing is achieved by touching the throwing button.

Operation 2203: Start a throwing skill and synchronize a state.

After the player touches the throwing button, the terminal sends a synchronization notification to the server, and the corresponding user interface of the terminal displays the start of the virtual prop performance.

Operation 2204: Whether to long-press.

It is determined whether the player long-presses the throwing button, and a throwing state is switched according to a pressing time. If the pressing time reaches a threshold, the aiming mode is directly entered and operation 2205 is performed. If the pressing time does not reach the threshold, the fast throwing mode is directly entered and operation 2211 is performed.

Operation 2205: Enter an aiming mode.

When the pressing time reaches the threshold, the aiming mode is directly entered. The aiming joystick corresponding to the selected container prop and the aiming front sight are displayed.

Operation 2206: A state of the aiming front sight changes.

When entering the aiming mode, the aiming joystick corresponding to the selected container prop and the aiming front sight are displayed, and the display style of the aiming front sight displays different contents according to different virtual aiming objects at the aiming location.

Operation 2207: Calculate a start location of a camera lens.

When entering the aiming mode, the terminal calculates the start location of the camera lens, that is, determines the initial aiming location of the aiming front sight.

Operation 2208: Move the aiming front sight in eight directions.

When entering the aiming mode, through the touch aiming operation on the aiming joystick, the aiming front sight is controlled to move in the eight directions, that is, by controlling the movement of the camera lens, the aiming front sight can be moved in the eight directions.

Operation 2209: Determine a virtual aiming object that the aiming front sight aims at.

When entering the aiming mode, the virtual aiming object that the aiming front sight aims at is determined.

Operation 2210: Display interactive information.

When entering the aiming mode, the virtual aiming object that the aiming front sight aims at is determined, and interactive information is displayed on the user interface.

For example, in the case that the selected container prop is the first container prop and the aiming front sight aims at the third pet virtual character, the aiming front sight having a “pet avatar” style is displayed, where the aiming front sight having the “pet avatar” style is used to indicate that the thrown first pet virtual character is used to engage in combats with the third pet virtual character. In a case that the selected container prop is the first container prop and the aiming front sight aims at the virtual collection object, the aiming front sight having a “palm” style is displayed, where the aiming front sight having the “palm” style is used to indicate that the thrown first pet virtual character is used to collect virtual collection objects. In a case that the selected container prop is the second container prop and the aiming front sight aims at the second pet virtual character, the aiming front sight having a “container prop” style is displayed, where the aiming front sight having the “container prop” style is used to indicate that the thrown second container prop is used to capture the second pet virtual character. In a case that there is no virtual aiming object at the aiming location of the aiming front sight, the aiming front sight appears in a “cross star” style.

Operation 2211: Calculate a start location of a camera lens.

When entering the fast throwing mode, the terminal calculates the start location of the camera lens, that is, determines the initial aiming location of the aiming front sight.

Operation 2212: Calculate a throwing direction and add direction correction.

When the virtual prop is thrown, the thrown virtual prop is regenerated in front of the center of the camera lens. The generation location is calculated based on the distance of the camera lens from the player, to ensure that under any arm length of the camera lens, the distance between the generation location and the player remains unchanged.

When the virtual prop is thrown, the server calculates the throwing direction. If the target landing point is automatically locked, the throwing direction is calculated based on the target landing point. Otherwise, the throwing direction is calculated based on the direction of the camera lens.

Operation 2213: Calculate throwing force and gravity, and correct the force according to the direction.

When the virtual prop is thrown, the server calculates the throwing force and corrects the throwing force according to the throwing direction to simulate the difficulty of throwing at different angles in the real environment. At the same time, the server corrects the gravity increase or decrease of the virtual prop to simulate the trajectory performance of various virtual props with unique characteristics. During automatic locking, the appropriate throwing angle is inferred based on the location of the target landing point. In a non-automatic locking state, the current angle is used as the standard for fast throwing and precise throwing, different planning configuration data is read respectively, and parameter correction values of different throwing virtual props are obtained to achieve better throwing performance.

Operation 2214: Play a throwing animation, set a throwing motion, and send network synchronization.

After determining the different planning configuration data, the throwing motion of the virtual prop is simulated. At the same time, the terminal and the server are synchronized to display the throwing effect on the user interface.

Operation 2215: Clear a throwing state.

Operation 2216: End.

FIG. 23 is a schematic structural diagram of a human-computer interaction apparatus based on virtual world according to an exemplary aspect of this disclosure. The apparatus can be implemented as all or part of a computer device through software, hardware, or a combination of both. The apparatus includes:
a display module 2301, configured to display a list control, the list control including a control corresponding to at least one container prop, and the at least one container prop including a first container prop that contains a first pet virtual character, and/or a second container prop that does not contain a pet virtual character;
the display module 2301 is configured to: in response to a touch selection operation on the control corresponding to the container prop, display an aiming joystick corresponding to the selected container prop and displaying an aiming front sight;
in response to a touch aiming operation on the aiming joystick, display the aiming front sight whose aiming location is changed;
the display module 2301 is configured to: display the thrown first pet virtual character in response to a touch throwing operation and that the selected container prop is the first container prop, the first pet virtual character being configured to interact with the virtual world; and
the display module 2301 is configured to: display the thrown second container prop in response to the touch throwing operation and that the selected container prop is the second container prop.

In a possible implementation, the display module 2301 is configured to display an aiming front sight having an interactive style, where a display style of the aiming front sight having the interactive style is related to a virtual aiming object located at the aiming location.

In a possible implementation, the display module 2301 is configured to: in response to that the selected container prop is the second container prop and the aiming front sight aims at the second pet virtual character, display the aiming front sight having a first interactive style;
where the first interactive style is used to indicate that the thrown second container prop is used to capture the second pet virtual character.

In a possible implementation, the display module 2301 is configured to display a capture success rate identifier of the second pet virtual character, where the capture success rate identifier is used to identify a success rate of the second container prop in capturing the second pet virtual character.

In a possible implementation, the display module 2301 is configured to: in a case that the second container prop successfully captures the second pet virtual character, display the second container prop that successfully captures the second pet virtual character.

In a possible implementation, the display module 2301 is configured to: in response to that the selected container prop is the first container prop and the aiming front sight aims at a virtual collection object, display the aiming front sight having a second interactive style;
where the second interactive style is used to indicate that the thrown first pet virtual character is configured for collecting the virtual collection object.

In a possible implementation, the display module 2301 is configured to: in response to that the selected container prop is the first container prop and the aiming front sight aims at a third pet virtual character, displaying the aiming front sight having a third interactive style;
where the third interactive style is used to indicate that the thrown first pet virtual character is configured for combating with the third pet virtual character.

In a possible implementation, the display module 2301 is configured to: display an interactive behavior between the first pet virtual character and the virtual environment at a location of the first pet virtual character, where the interactive behavior is related to an attribute of the first pet virtual character.

In a possible implementation, the display module 2301 is configured to: change, based on the attribute of the first pet virtual character, display of an attribute of a land parcel where the first pet virtual character is located in the virtual environment.

In a possible implementation, the display module 2301 is configured to open or close a virtual treasure box at the location of the first pet virtual character based on the attribute of the first pet virtual character, where the virtual treasure box is used to place a virtual prop.

In a possible implementation, the display module 2301 is configured to trigger a virtual potential energy mechanism in the virtual environment based on the attribute of the first pet virtual character;
where the virtual potential energy mechanism is configured for changing an attribute intensity value of a pet virtual character within a potential energy range of the virtual potential energy mechanism.

In a possible implementation, the display module 2301 is configured to: in response to that the container prop collides with a collision surface in a throwing process, display a collision trajectory after the container prop collides with the collision surface.

In a possible implementation, the display module 2301 is configured to: in response to that an angle between a throwing direction of the container prop and the collision surface is greater than an angle threshold, display a rebound trajectory of the container prop after the collision with the collision surface.

In a possible implementation, the display module 2301 is configured to: in response to that an angle between a throwing direction of the container prop and the collision surface is less than or equal to an angle threshold, display a continuous bouncing trajectory of the container prop continuously bouncing on the collision surface.

In a possible implementation, the display module 2301 is configured to display a first list control on the left side of a user interface in a listing manner, where the first list control includes a control corresponding to at least one first container prop;

and/or display a second list control on the lower side of the user interface in an overlay manner, where the second list control includes a control corresponding to at least one second container prop.

In a possible implementation, the display module 2301 is configured to: in response to a triggering operation on the control corresponding to the first container prop, display a selection identifier in a first direction of the control corresponding to the first pet virtual character.

In a possible implementation, the display module 2301 is configured to: in response to a triggering operation on the control corresponding to the second container prop, display a selection identifier in a second direction of the control corresponding to the second container prop;
where the first direction is opposite to the second direction.

In a possible implementation, the display module 2301 is configured to display the aiming joystick on the user interface in a combined manner, where the aiming joystick includes a direction compass and a joystick button, and a display style of the joystick button corresponds to the selected container prop.

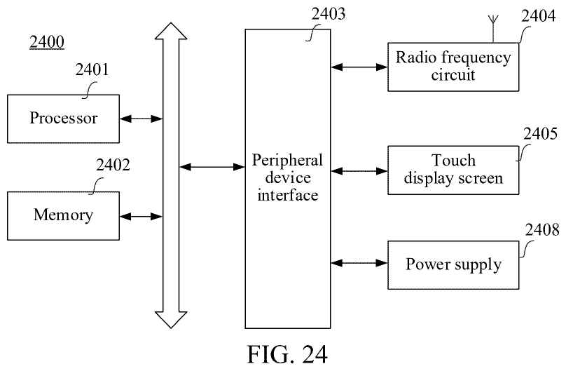

FIG. 24 is a structural block diagram of a computer device 2400 according to an exemplary aspect of this disclosure. The computer device 2400 can be a portable mobile terminal, for example, a smartphone, a tablet computer, a moving picture experts group audio layer III (MP3) player, or a moving picture experts group audio layer IV (MP4) player. The computer device 2400 may also be called a user device, a portable terminal, or other names.

Generally, the computer device 2400 includes: a processor 2401 and a memory 2402.

The processor 2401 may include one or more processing cores, for example, a 4-core processor or an 8-core processor. The processor 2401 may be implemented in at least one hardware form of a digital signal processor (DSP), a field-programmable gate array (FPGA), and a programmable logic array (PLA). The processor 2401 may also include a main processor and a co-processor. The main processor is a processor configured to process data in an awake state, and is also referred to as a central processing unit (CPU). The co-processor is a low power consumption processor configured to process the data in a standby state. In some aspects, the processor 2401 may be integrated with a graphics processing unit (GPU). The GPU is configured to render and draw content that needs to be displayed on a display screen. In some aspects, the processor 2401 may further include an artificial intelligence (AI) processor. The AI processor is configured to process computing operations related to machine learning.

The memory 2402 may include one or more computer-readable storage mediums. The computer-readable storage medium may be visible and non-transient. The memory 2402 may further include a high-speed random access memory and a nonvolatile memory, for example, one or more disk storage devices or flash storage devices. In some aspects, the non-transient computer-readable storage medium in the memory 2402 is configured to store at least one instruction, and the at least one instruction being configured to be executed by the processor 2401 to implement the human-computer interaction method based on virtual world provided in the aspects of this disclosure.

In some aspects, the computer device 2400 further includes: a peripheral device interface 2403 and at least one peripheral device. Specifically, The peripheral device includes: at least one of a radio frequency circuit 2404, a touch display screen 2405, and a power supply 2408.

The peripheral device interface 2403 may be configured to connect the at least one peripheral device related to input/output (I/O) to the processor 2401 and the memory 2402. In some aspects, the processor 2401, the memory 2402, and the peripheral device interface 2403 are integrated on the same chip or circuit board. In some other aspects, any one or two of the processor 2401, the memory 2402 and the peripheral device interface 2403 may be implemented on a single chip or circuit board. This is not limited in this aspect.

The radio frequency circuit 2404 is configured to receive and transmit a radio frequency (RF) signal, also referred to as an electromagnetic signal. The radio frequency circuit 2404 communicates with a communication network and other communication devices through the electromagnetic signal. The radio frequency circuit 2404 converts an electric signal into an electromagnetic signal for transmission, or converts a received electromagnetic signal into an electric signal. In some aspects, the radio frequency circuit 2404 includes: an antenna system, an RF transceiver, one or more amplifiers, a tuner, an oscillator, a digital signal processor, a codec chip set, a subscriber identity module card, and the like. The radio frequency circuit 2404 may communicate with another terminal by using at least one wireless communications protocol. The wireless communications protocol includes but is not limited to: a worldwide web, a metropolitan area network, an intranet, generations of mobile communication networks (2G, 3G, 4G, and 5G), a wireless local area network and/or a Wi-Fi network.

The touch display screen 2405 is configured to display a user interface (UI). The UI may include a graph, a text, an icon, a video, and any combination thereof. The touch display screen 2405 further has a capability of acquiring a touch signal on or above a surface of the touch display screen 2405. The touch signal may be inputted to the processor 2401 as a control signal for processing. The touch display screen 2405 is configured to provide a virtual button and/or a virtual keyboard that are/is also referred to as a soft button and/or a soft keyboard. In some aspects, there may be one touch display screen 2405, which is disposed on the front panel of the computer device 2400. In some other aspects, there may be at least two touch display screens 2405, which are respectively disposed on different surfaces of the computer device 2400 or have a folding design. In some aspects, the touch display screen 2405 may be a flexible display screen disposed on a curved or folded surface of the computer device 2400. Even, the touch display screen 2405 may be further disposed in a non-rectangular irregular pattern, namely, a special-shaped screen. The touch display screen 2405 may be prepared by using materials such as a liquid crystal display (LCD), an organic light-emitting diode (OLED), or the like.

The power supply 2408 is configured to supply power to components in the computer device 2400. The power supply 2408 may be an alternating current battery, a direct current battery, a primary battery, or a rechargeable battery. When the power supply 2408 includes a rechargeable battery, and the rechargeable battery may be a wired rechargeable battery or a wireless rechargeable battery. The wired rechargeable battery is a battery charged through a wired circuit, and the wireless rechargeable battery is a battery charged through a wireless coil. The rechargeable battery may be further configured to support a fast charging technology.

A person skilled in the art may understand that the structure shown in FIG. 24 constitutes no limitation on the computer device 2400, and the computer device may include more or fewer components than those shown in the figure, or some components may be combined, or a different component deployment may be used.

An aspect of this disclosure further provides a computer device, including: a processor and a memory, the memory storing at least one computer program, and the at least one computer program being loaded and executed by the processor to implement the human-computer interaction method based on virtual world according to the foregoing method aspects.

An aspect of this disclosure further provides a computer storage medium, storing at least one computer program, and the at least one computer program being loaded and executed by a processor to implement the human-computer interaction method based on virtual world according to the foregoing method aspects.

The term module (and other similar terms such as unit, submodule, etc.) in this disclosure may refer to a software module, a hardware module, or a combination thereof. A software module (e.g., computer program) may be developed using a computer programming language. A hardware module may be implemented using processing circuitry and/or memory. Each module can be implemented using one or more processors (or processors and memory). Likewise, a processor (or processors and memory) can be used to implement one or more modules. Moreover, each module can be part of an overall module that includes the functionalities of the module.

The foregoing disclosure includes some exemplary embodiments of this disclosure which are not intended to limit the scope of this disclosure. Other embodiments shall also fall within the scope of this disclosure.

What is claimed is:

1. A human-computer interaction method, comprising:
displaying a main virtual character in a virtual environment;
displaying, by processing circuitry, a list interface including a first control corresponding to a container prop that is possessed by the main virtual character and contains a first pet virtual character;
displaying release of the first pet virtual character in the virtual environment based on a throwing operation indicative of a throw of the container prop, the throwing operation being based on at least the first control included in the list interface; and
displaying, by the processing circuitry, an interaction between the first pet virtual character and the virtual environment at a location of the first pet virtual character in the virtual environment based on a first attribute of the first pet virtual character.

2. The method according to claim 1, wherein
the displaying the interaction between the first pet virtual character and the virtual environment includes triggering a virtual potential energy mechanism in the virtual environment based on the first attribute of the first pet virtual character;
the virtual potential energy mechanism is associated with an attribute identifier related to the first attribute of the first pet virtual character; and
the virtual potential energy mechanism is configured to change an attribute intensity value of the first pet virtual character when the first pet virtual character is within a potential energy range of the virtual potential energy mechanism.

3. The method according to claim 2, wherein
the first attribute of the first pet virtual character corresponds to a first type, and
the virtual potential energy mechanism is configured to, within the potential energy range of the virtual potential energy mechanism,
activate a restrain relationship between the attribute corresponding to the first type and an attribute corresponding to a second type, and/or
activate a counter-restrain relationship between the attribute corresponding to the first type and an attribute corresponding to a third type.

4. The method according to claim 3, further comprising:
when the first pet virtual character within the potential energy range of the virtual potential energy mechanism is attacked by a second pet virtual character having a second attribute corresponding to the second type, reducing a damage value to the first pet virtual character caused by the second pet virtual character based on the virtual potential energy mechanism; or
when the first pet virtual character within the potential energy range of the virtual potential energy mechanism attacks a third pet virtual character having a third attribute corresponding to the third type, increasing a damage value to the third pet virtual character caused by the first pet virtual character based on the virtual potential energy mechanism.

5. The method according to claim 2, wherein
the attribute identifier of the virtual potential energy mechanism and the first attribute of the first pet virtual character correspond to a same type, and
the virtual potential energy mechanism is configured to enhance the attribute intensity value of the first pet virtual character when the first pet virtual character is within the potential energy range of the virtual potential energy mechanism.

6. The method according to claim 1, wherein
the interaction includes open or close of a virtual treasure box at the location of the first pet virtual character in the virtual environment based on the first attribute of the first pet virtual character, and
the virtual treasure box is configured to hold a virtual prop.

7. The method according to claim 1, further comprising:
displaying an aiming sight and an aiming interface based on a selection operation of the first control; and
updating a display position of the aiming sight based on an aiming operation of the aiming interface.

8. The method according to claim 1, further comprising:
when the container prop collides with a collision surface in the virtual environment during a throwing process, displaying a collision trajectory after the container prop collides with the collision surface.

9. The method according to claim 1, further comprising:
displaying a selection identifier corresponding to the first pet virtual character based on a triggering operation of the first control corresponding to the container prop.

10. A human-computer interaction apparatus, comprising:
processing circuitry configured to:
display a main virtual character in a virtual environment;
display a list interface including a first control corresponding to a container prop that is possessed by the main virtual character and contains a first pet virtual character;
display release of the first pet virtual character in the virtual environment based on a throwing operation indicative of a throw of the container prop, the throwing operation being based on at least the first control included in the list interface; and
display an interaction between the first pet virtual character and the virtual environment at a location of the first pet virtual character in the virtual environment based on a first attribute of the first pet virtual character.

11. The apparatus according to claim 10, wherein
to display the interaction between the first pet virtual character and the virtual environment, the processing circuitry is configured to trigger a virtual potential energy mechanism in the virtual environment based on the first attribute of the first pet virtual character;
the virtual potential energy mechanism is associated with an attribute identifier related to the first attribute of the first pet virtual character; and
the virtual potential energy mechanism is configured to change an attribute intensity value of the first pet virtual character when the first pet virtual character is within a potential energy range of the virtual potential energy mechanism.

12. The apparatus according to claim 11, wherein
the first attribute of the first pet virtual character corresponds to a first type, and
the virtual potential energy mechanism is configured to, within the potential energy range of the virtual potential energy mechanism,
activate a restrain relationship between the attribute corresponding to the first type and an attribute corresponding to a second type, and/or
activate a counter-restrain relationship between the attribute corresponding to the first type and an attribute corresponding to a third type.

13. The apparatus according to claim 12, wherein the processing circuitry is configured to:
when the first pet virtual character within the potential energy range of the virtual potential energy mechanism is attacked by a second pet virtual character having a second attribute corresponding to the second type, reduce a damage value to the first pet virtual character caused by the second pet virtual character based on the virtual potential energy mechanism; or
when the first pet virtual character within the potential energy range of the virtual potential energy mechanism attacks a third pet virtual character having a third attribute corresponding to the third type, increase a damage value to the third pet virtual character caused by the first pet virtual character based on the virtual potential energy mechanism.

14. The apparatus according to claim 11, wherein
the attribute identifier of the virtual potential energy mechanism and the first attribute of the first pet virtual character correspond to a same type, and
the virtual potential energy mechanism is configured to enhance the attribute intensity value of the first pet virtual character when the first pet virtual character is within the potential energy range of the virtual potential energy mechanism.

15. The apparatus according to claim 10, wherein
the interaction includes open or close of a virtual treasure box at the location of the first pet virtual character in the virtual environment based on the first attribute of the first pet virtual character, and
the virtual treasure box is configured to hold a virtual prop.

16. The apparatus according to claim 10, wherein the processing circuitry is configured to:
display an aiming sight and an aiming interface based on a selection operation of the first control; and
update a display position of the aiming sight based on an aiming operation of the aiming interface.

17. The apparatus according to claim 10, wherein the processing circuitry is configured to:
when the container prop collides with a collision surface in the virtual environment during a throwing process, display a collision trajectory after the container prop collides with the collision surface.

18. The apparatus according to claim 10, wherein the processing circuitry is configured to:
display a selection identifier corresponding to the first pet virtual character based on a triggering operation of the first control corresponding to the container prop.

19. A non-transitory computer-readable storage medium storing instructions, which, when executed by a processor, cause the processor to perform:
displaying a main virtual character in a virtual environment;
displaying a list interface including a first control corresponding to a container prop that is possessed by the main virtual character and contains a first pet virtual character;
displaying release of the first pet virtual character in the virtual environment based on a throwing operation indicative of a throw of the container prop, the throwing operation being based on at least the first control included in the list interface; and
displaying an interaction between the first pet virtual character and the virtual environment at a location of the first pet virtual character in the virtual environment based on a first attribute of the first pet virtual character.

20. The non-transitory computer-readable storage medium according to claim 19, wherein
the displaying the interaction between the first pet virtual character and the virtual environment includes triggering a virtual potential energy mechanism in the virtual environment based on the first attribute of the first pet virtual character;
the virtual potential energy mechanism is associated with an attribute identifier related to the first attribute of the first pet virtual character; and
the virtual potential energy mechanism is configured to change an attribute intensity value of the first pet virtual character when the first pet virtual character is within a potential energy range of the virtual potential energy mechanism.
